(19) United States
(12) Patent Application Publication
(10) Pub. No.: US 2025/0152986 A1
(43) Pub. Date: May 15, 2025

(54) FOAM STABILIZING COMPOSITION FOR FLUORINE-FREE FIREFIGHTING FOAMS

(71) Applicants: DOW SILICONES CORPORATION, Midland, MI (US); DOW GLOBAL TECHNOLOGIES LLC, Midland, MI (US)

(72) Inventors: Anirudha BANERJEE, Midland, MI (US); Zachary WENZLICK, Midland, MI (US); Yusen QIAO, Midland, MI (US)

(21) Appl. No.: 18/725,705

(22) PCT Filed: Dec. 30, 2022
(86) PCT No.: PCT/US2022/054315

§ 371 Date: Jun. 28, 2024

Related U.S. Application Data
(60) Provisional application No. 63/295,686, filed on Dec. 31, 2021.

(51) Int. Cl. A62D 1/02; C08K 5/19; C08K 5/544

(52) U.S. Cl. CPC A62D 1/0071; C08K 5/19; C08K 5/544

(57) ABSTRACT

A foam stabilizing composition comprises (A) an anionic polymer and (B) a siloxane cationic surfactant comprising a cationic moiety having the formula Z¹-D¹-N(Y)ₐ(R)₂₋ₐ, wherein Z¹ is a siloxane moiety, D¹ is a divalent linking group, R is H or an unsubstituted hydrocarbyl group having from 1 to 4 carbon atoms, subscript a is 1 or 2, and each Y has formula -D-NR¹₃⁺, where D is a divalent linking group and each R¹ is independently an unsubstituted hydrocarbyl group having from 1 to 4 carbon atoms. An aqueous foam comprising the composition and method of using the same are also disclosed.

### CROSS-REFERENCE TO RELATED APPLICATIONS

This application claims priority to and all advantages of U.S. Application No. 63/295,686 filed on 31 Dec. 2021, the content of which is herein incorporated by reference.

### FIELD OF THE INVENTION

The present disclosure relates generally to foam compositions and, more specifically, to a foam stabilizing composition, an aqueous foam composition comprising the same, and a method of preparing and using the same.

### DESCRIPTION OF THE RELATED ART

Surfactants and surfactant compositions are known in the art and are utilized in myriad end use applications and environments. In particular, surfactants and surfactant compositions are utilized in numerous industrial, commercial, home care, and personal care formulations. As but one example, surfactants and surfactant compositions are commonly utilized in the preparation of a wide variety of surface treatments and coating compositions, e.g. to influence the characteristics of the compositions themselves as well as to provide surface effects to substrates threated with such surface treatment/coating compositions. For example, polyfluoroalkyl-based surfactants and compositions thereof have been widely employed in industrial compositions as fume suppressants and etching additives, in surface treatments for imparting water and oil repellency to the surface of articles such as carpeting, upholstery, apparel, textiles, etc., as well as in many commercial products such as cleaning compositions, waxes, sealants, and foams. Additionally, fluorinated surfactants have been utilized in numerous conventional aqueous film-forming foams (AFFFs), which have previously enjoyed widespread use in preventing, containing, and/or extinguishing fires.

Unfortunately, however, per- and poly-fluoroalkyl-based surfactants have been shown to decompose or otherwise degrade under environmental conditions to give numerous fluorochemicals, some of which have been found to be environmentally persistent due to many of the desired properties of such compounds that resulted in their wide-spread use (e.g. high chemical resistance, wide chemical compatibility, high lipophobicity, etc.). As such, fluorinated surfactants are increasingly being phased out of production and use, leading to many widely utilized surfactants and surfactant compositions becoming unavailable for continued use.

### BRIEF SUMMARY

The present disclosure provides a foam stabilizing composition. The foam stabilizing composition comprises (A) an anionic polymer; and (B) a siloxane cationic surfactant having general formula (I):

[Z¹-D¹-N(Y)ₐ(R)₂₋ₐ]^{+y}[X^{-x}]ₙ (I),

wherein Z¹ is a siloxane moiety; D¹ is a divalent linking group; R is H or an unsubstituted hydrocarbyl group having from 1 to 4 carbon atoms; each Y has formula -D-NR¹₃_{⁺}, where D is a divalent linking group and each R¹ is independently an unsubstituted hydrocarbyl group having from 1 to 4 carbon atoms; subscript a is 1 or 2; 1≤y≤3; X is an anion; subscript n is 1, 2, or 3; and 1≤x≤3, with the proviso that (x*n)=y. At least one of the following provisos is true: (i) components (A) and (B) are present in the foam stabilizing composition in a weight ratio of from 0.5:1 to 3.5:1 (A)/(B); and/or (ii) components (A) and (B) are present in the foam stabilizing composition to provide a molar ratio of anionic groups in component (A) to cationic groups in component (B) of from 1:1 to 6.5:1.

The present disclosure further provides an aqueous foam comprising the foam stabilizing composition, and methods relating to preparing and using the same.

### DESCRIPTION OF THE DRAWINGS

Various advantages and aspects of this disclosure may be understood in view of the following detailed description when considered in connection with the accompanying drawings, wherein:

FIG. 1 shows a plot of extinction time (seconds) as a function of flow rate (mL/min) for certain embodiments of the invention as described in the examples hereof; and

FIG. 2 shows another plot of extinction time (seconds) as a function of flow rate (mL/min) for certain embodiments of the invention as described in the examples hereof.

### DETAILED DESCRIPTION

A foam stabilizing composition (the “composition”) is provided. The composition may be utilized in foam compositions (i.e., foams), including aqueous foaming compositions, expanded foam compositions, concentrated foam compositions and/or foam concentrates, etc., which may be formulated and/or utilized in diverse end-use applications. For example, as will be appreciated from this disclosure, the composition may be utilized in an aqueous foams or similar foaming composition suitable for use in extinguishing, suppressing, and/or preventing fire. The composition has excellent performance properties even while being free from polyfluoroalkyl-based surfactants or other fluorine sources.

The composition comprises (A) an anionic polymer and (B) a siloxane cationic surfactant. The anionic polymer (A) and siloxane cationic surfactant (B) are described in turn below, along with additional/optional components that may be utilized in the composition, which may be individually referred to herein as “component (A)”, “component (B)”, etc., respectively, and collectively as the “components” of the composition.

As introduced above, component (A) of the composition is an anionic polymer. The anionic polymer (A) is not limited. In certain embodiments, the anionic polymer (A) is soluble in water, meaning that the anionic polymer (A) can form a homogenous solution when disposed in water, optionally under shear or mixing.

In certain embodiments, the anionic polymer (A) comprises, alternatively is, a polyelectrolyte. As used herein, the term “polymer” and “polyelectrolyte” with reference to component (A) includes, but is not limited to, homopolymers, copolymers, such as graft, random and alternating copolymers, terpolymers, etc. and blends and modifications thereof. Furthermore, unless otherwise specifically limited, the term “polymer” and “polyelectrolyte” shall include all possible geometrical configurations of the molecule. These configurations include, but are not limited to isotactic, syndiotactic and random symmetries. In general, the term “polyelectrolyte”, as used herein, means a polymer having at least one permanent anionic charge when dissolved in an aqueous solution. As used herein, the term “polyelectrolyte” also means a polymer capable of forming an anionic charge, when dissolved in an aqueous solution whose pH has been adjusted by some means including the addition of an acid or suitable buffering agent, so as to form a net anionic charge on the polymer in water.

Further, the acidic nature of the anionic polymer (A) may be provided or imparted by a native acid moiety, or may result from the hydrolysis of one or more anhydride moieties, as in the conversion of a succinic anhydride moiety to a succinic diacid moiety. Thus, the anionic polymer can be any that has a carboxylic acid moiety, maleic acid moiety, acetylacetone moiety, phosphoric acid moiety, sulfonic acid moiety, salts thereof, and half esters thereof.

Suitable anionic polymers can be exemplified by acrylate ester/methacrylate ester copolymers, vinyl acetate/crotonic acid copolymers, vinyl acetate/crotonic acid/vinyl neodecanoate copolymers, methyl vinyl ether/maleate hemiester, t-butyl acrylate/ethyl acrylate/methacrylic acid copolymers, vinylpyrrolidone/vinyl acetate/vinyl propionate copolymers, vinyl acetate/crotonic acid copolymers, vinyl acetate/crotonic acid/vinylpyrrolidone copolymers, vinylpyrrolidone/acrylate copolymers, acrylate/acrylamide copolymers, vinyl acetate/butyl maleate/isobornyl acrylate copolymers, alkanolamine acrylic resins, urethane-modified acrylic polymers, ethylene-acrylic acid copolymers, maleic anhydride grafted polyethylene, ethylene acrylic acid copolymer neutralized with sodium or zinc salt, polystyrene sulfonic acid, styrene-maleic anhydride copolymer, and polycarboxylate polymers and copolymers of acrylic acid and maleic anhydride or alkali metal salts. Also suitable are polymers containing monomers capable of taking on an anionic charge in aqueous solutions when dissolved in water that has been adjusted to an appropriate pH using an acid, a buffer or combination thereof. Examples include acrylic acid, maleic acid, methacrylic acid, ethacrylic acid, dimethylacrylic acid, maleic anhydride, succinic anhydride, vinylsulfonate, cyanoacrylic acid, methylenemalonic acid, vinylacetic acid, allylacetic acid, ethylidineacetic acid, propylidineacetic acid, crotonic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, vinylbenzoic acid, N-vinylsuccinamidic acid, mesaconic acid, carboxylic acid, phosphoric acids sulfonic acid, acetylacetone, half-esters, half-acids, maleic acid anhydride, methyl vinyl ethers, vinylpyrrolidone based compounds or their salts, methacroylalanine, acryloylhydroxyglycine, sulfoethyl methacrylate, sulfopropyl acrylate, and sulfoethyl acrylate. Suitable acid monomers also include styrenesulfonic acid, acrylamide methyl propane sulfonic acid, 2-methacryloyloxy-methane-1-sulfonic acid, 3-methacryloyloxy-propane-1-sulfonic acid, 3-(vinyloxy)-propane-1-sulfonic acid, ethylenesulfonic acid, vinyl sulfuric acid, 4-vinylphenyl sulfuric acid, ethylene phosphonic acid and vinyl phosphoric acid.

Also suitable are natural anionic polymers, including but not limited to saccharinic gums and/or polysaccharides, including alginates, xanthates, pectins, carrageenans, guar, carboxymethyl cellulose, sodium carboxymethyl cellulose, carboxymethyl dextran, sodium carboxymethyl dextra, scleroglucans, and combinations thereof.

In certain embodiments, the anionic polymer (A) includes at least one anionic group selected from a carboxyl group, a sulfonic group, a sulfato group, a phosphonic group, and a phosphate group. In specific embodiments, the anionic polymer (A) comprises, alternatively is, a polysaccharide having at least one of these anionic groups. It is to be appreciated that the term “saccharide” may be used synonymously with the term “carbohydrate” under general circumstances, and terms like “sugar” under more specific circumstances. As such, the nomenclature of any particular saccharide is not exclusionary with regard to suitable saccharide compounds for use in or as the anionic polymer (A). Suitable saccharides may include, alternatively may be, any compound comprising a moiety that can be described as a saccharide, carbohydrate, sugar, starch, cellulose, and the like, or a derivative or modification thereof, or combinations thereof. Likewise, any combination of more than one saccharide moiety in the saccharide compounds may be described more descriptive terms. For example, the term “polysaccharide” may be used synonymously with the term “glycoside,” where both terms generally refer to a combination of more than one saccharide moiety (e.g. where the combination of saccharide moieties are linked together via glycosidic linkage(s) and collectively form a glycoside moiety). One of skill in the art will appreciate that terms such as “starch” and “cellulose” may be used to refer to such combinations of saccharide moieties under specific circumstances (e.g. when a combination of more than one saccharide moiety in the saccharide compound conforms to the structure known in the art as a “starch” or a “cellulose”, etc.).

As such, examples of polysaccharides suitable for use in or as the anionic polymer (A) may include compounds, or compounds comprising two or more moieties conventionally referred to as a monosaccharide and/or sugar (e.g. pentoses (i.e., furanoses), such as riboses, xyloses, arabinoses, lyxoses, fructoses, etc., and hexoses (i.e., pyranoses), such as glucoses, galactoses, mannoses, guloses, idoses, taloses, alloses, altroses, etc.). Polysaccharides include celluloses, hemicelluloses, pectins, glycogens, hydrocolloids, starches such as amyloses, amylopectins, etc., and derivatives and combinations thereof.

The anionic polymer (A) may include a combination of different anionic groups. In addition, the anionic polymer (A) may comprise a blend or two or more different anionic polymers, which differ in terms of molecular weight, anionic content, anionic functional group, etc.

As introduced above, the composition further comprises (B) a siloxane cationic surfactant, i.e., a complex comprising a cationic organosilicon compound charge-balanced with a counter ion. In particular, the siloxane cationic surfactant (B) comprises a siloxane moiety and one or more quaternary ammonium moieties, and conforms to general formula (I):

[Z¹-D¹-N(Y)ₐ(R)₂₋ₐ]^{+y}[X^{-x}]ₙ (I),

wherein Z¹ is a siloxane moiety; D¹ is a divalent linking group; R is H or an unsubstituted hydrocarbyl group having from 1 to 4 carbon atoms; each Y has formula -D-NR¹₃_{⁺}, where D is a divalent linking group and each R¹ is independently an unsubstituted hydrocarbyl group having from 1 to 4 carbon atoms; subscript a is 1 or 2; 1≤y≤3; X is an anion; subscript n is 1, 2, or 3; and 1≤x≤3, with the proviso that (x*n)=y.

With regard to formula (I), as introduce above, Z¹ represents a siloxane moiety. In general, the siloxane moiety Z¹ comprises a siloxane and is otherwise not particularly limited. As understood in the art, siloxanes comprise an inorganic silicon-oxygen-silicon group (i.e., —Si—O—Si—), with organosilicon and/or organic side groups attached to the silicon atoms. As such, siloxanes may be represented by the general formula ([R^{x}ᵢSiO_{(4-i)/2}]ₕ)ⱼ(R^{x})₃₋ⱼSi—, where subscript i is independently selected from 1, 2, and 3 in each moiety indicated by subscript h, subscript h is at least 1, subscript j is 1, 2, or 3, and each R^{x} is independently selected from hydrocarbyl groups, alkoxy and/or aryloxy groups, and siloxy groups.

Hydrocarbyl groups suitable for Rₓ include monovalent hydrocarbon moieties, as well as derivatives and modifications thereof, which may independently be substituted or unsubstituted, linear, branched, cyclic, or combinations thereof, and saturated or unsaturated. With regard to such hydrocarbyl groups, the term “unsubstituted” describes hydrocarbon moieties composed of carbon and hydrogen atoms, i.e., without heteroatom substituents. The term “substituted” describes hydrocarbon moieties where either at least one hydrogen atom is replaced with an atom or group other than hydrogen (e.g. a halogen atom, an alkoxy group, an amine group, etc.) (i.e., as a pendant or terminal substituent), a carbon atom within a chain/backbone of the hydrocarbon is replaced with an atom other than carbon (e.g. a heteroatom, such as oxygen, sulfur, nitrogen, etc.) (i.e., as a part of the chain/backbone), or both. As such, suitable hydrocarbyl groups may comprise, or be, a hydrocarbon moiety having one or more substituents in and/or on (i.e., appended to and/or integral with) a carbon chain/backbone thereof, such that the hydrocarbon moiety may comprise, or be, an ether, an ester, etc. Linear and branched hydrocarbyl groups may independently be saturated or unsaturated and, when unsaturated, may be conjugated or nonconjugated. Cyclic hydrocarbyl groups may independently be monocyclic or polycyclic, and encompass cycloalkyl groups, aryl groups, and heterocycles, which may be aromatic, saturated and nonaromatic and/or non-conjugated, etc. Examples of combinations of linear and cyclic hydrocarbyl groups include alkaryl groups, aralkyl groups, etc. General examples of hydrocarbon moieties suitably for use in or as the hydrocarbyl group include alkyl groups, aryl groups, alkenyl groups, alkynyl groups, halocarbon groups, and the like, as well as derivatives, modifications, and combinations thereof. Examples of alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, and the like (i.e., other linear or branched saturated hydrocarbon groups, e.g. having greater than 6 carbon atoms). Examples of aryl groups include phenyl, tolyl, xylyl, naphthyl, benzyl, dimethyl phenyl, and the like, as well as derivatives and modifications thereof, which may overlap with alkaryl groups (e.g. benzyl) and aralkyl groups (e.g. tolyl, dimethyl phenyl, etc.). Examples of alkenyl groups include vinyl, allyl, propenyl, isopropenyl, butenyl, isobutenyl, pentenyl, heptenyl, hexenyl, cyclohexenyl groups, and the like, as well as derivatives and modifications thereof. General examples of halocarbon groups include halogenated derivatives of the hydrocarbon moieties above, such as halogenated alkyl groups (e.g. any of the alkyl groups described above, where one or more hydrogen atoms is replaced with a halogen atom such as F or Cl), aryl groups (e.g. any of the aryl groups described above, where one or more hydrogen atoms is replaced with a halogen atom such as F or Cl), and combinations thereof. Examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, 3,4-difluoro-5-methylcycloheptyl, chloromethyl, chloropropyl, 2-dichlorocyclopropyl, 2,3-dichlorocyclopentyl, and the like, as well as derivatives and modifications thereof. Examples of halogenated aryl groups include chlorobenzyl, pentafluorophenyl, fluorobenzyl groups, and the like, as well as derivatives and modifications thereof.

Alkoxy and aryloxy groups suitable for R^{x} include those having the general formula —OR^{xi}, where R^{xi} is one of the hydrocarbyl groups set forth above with respect to R^{x}. Examples of alkoxy groups include methoxy, ethoxy, propoxy, butoxy, benzyloxy, and the like, as well as derivatives and modifications thereof. Examples of aryloxy groups include phenoxy, tolyloxy, pentafluorophenoxy, and the like, as well as derivatives and modifications thereof.

Examples of suitable siloxy groups suitable for R^{x} include [M], [D], [T], and [Q] units, which, as understood in the art, each represent structural units of individual functionality present in siloxanes, such as organosiloxanes and organopolysiloxanes. More specifically, [M] represents a monofunctional unit of general formula R^{xii}₃SiO_{1/2}; [D] represents a difunctional unit of general formula R^{xii}₂SiO_{2/2}; [T] represents a trifunctional unit of general formula R^{xii}SiO_{3/2}; and [Q] represents a tetrafunctional unit of general formula SiO_{4/2}, as shown by the general structural moieties below:

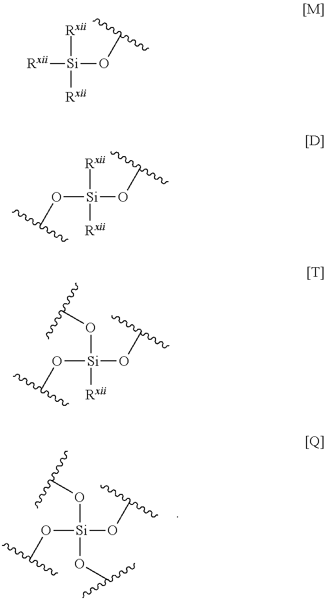

In these general structural moieties, each R^{xii} is independently a monovalent or polyvalent substituent. As understood in the art, specific substituents suitable for each R^{xii} are not limited, and may be monoatomic or polyatomic, organic or inorganic, linear or branched, substituted or unsubstituted, aromatic, aliphatic, saturated or unsaturated, and combinations thereof. Typically, each R^{xii} is independently selected from hydrocarbyl groups, alkoxy and/or aryloxy groups, and siloxy groups. As such, each R^{xii} may independently be a hydrocarbyl group of formula —R^{xi} or an alkoxy or aryloxy group of formula —OR^{xi}, where R^{xi} is as defined above, or a siloxy group represented by any one, or combination, of [M], [D], [T], and/or [Q] units described above.

The siloxane moiety Z¹ may be linear, branched, or combinations thereof, e.g. based on the number and arrangement of [M], [D], [T], and/or [Q] siloxy units present therein. When branched, the siloxane moiety Z¹ may minimally branched or, alternatively, may be hyperbranched and/or dendritic.

In certain embodiments, the siloxane moiety Z¹ is a branched siloxane moiety having the formula —Si(R³)₃, wherein at least one R³ is —OSi(R⁴)₃ and each other R³ is independently selected from R² and —OSi(R⁴)₃, where each R⁴ is independently selected from R², —OSi(R⁵)₃, and —[OSiR²₂]ₘOSiR²₃. With regard to these selections for R⁴, each R⁵ is independently selected from R², —OSi(R⁶)₃, and —[OSiR²₂]ₘOSiR²₃, and each R⁶ is independently selected from R² and —[OSiR²₂]ₘOSiR²₃. In each selection, R² is an independently selected substituted or unsubstituted hydrocarbyl group, such as any of those described above with respect to R^{x}, and each subscript m is individually selected such that 0≤m≤100 (i.e., in each selection where applicable).

As introduced above, each R³ is selected from R² and —OSi(R⁴)₃, with the proviso that at least one R³ is of formula —OSi(R⁴)₃. In certain embodiments, at least two of R³ are of formula —OSi(R⁴)₃. In specific embodiments, each R³ is of formula —OSi(R⁴)₃. It will be appreciated that a greater number of R³ being —OSi(R⁴)₃ increases the level of branching in the siloxane moiety Z¹. For example, when each R³ is —OSi(R⁴)₃, the silicon atom to which each R³ is bonded is a T siloxy unit. Alternatively, when two of R³ are of formula OSi(R⁴)₃, the silicon atom to which each R³ is bonded is a [D] siloxy unit. Moreover, when R³ is of formula —OSi(R⁴)₃, and when R⁴ is of formula —OSi(R⁵)₃, further siloxane bonds and branching are present in the siloxane moiety Z¹. This is further the case when R⁵ is of formula —OSi(R⁶)₃. As such, it will be understood by those of skill in the art that each subsequent R³+n moiety in the siloxane moiety Z¹ can impart a further generation of branching, depending on the particular selections thereof. For example, R⁴ can be of formula —OSi(R⁵)₃, and R⁵ can be of formula —OSi(R⁶)₃. Thus, depending on a selection of each substituent, further branching attributable to [T] and/or [Q] siloxy units may be present in the siloxane moiety Z¹ (i.e., beyond those of other substituents/moieties described above).

Each R⁴ is selected from R², —OSi(R⁵)₃, and —[OSiR²₂]ₘOSiR²₃, where 0≤m≤100. Depending on a selection of R⁴ and R⁵, further branching can be present in the siloxane moiety Z¹. For example, when each R⁴ is R², then each —OSi(R⁴)₃ moiety (i.e., each R³ of formula —OSi(R⁴)₃) is a terminal [M] siloxy unit. Said differently, when each R³ is —OSi(R⁴)₃, and when each R⁴ is R², then each R³ can be written as —OSiR²₃ (i.e., an [M] siloxy unit). In such embodiments, the siloxane moiety Z¹ includes a [T] siloxy unit bonded to group D in formula (I), which [T] siloxy unit is capped by three [M] siloxy units. Moreover, when of formula —[OSiR²₂]ₘOSiR²₃, R⁴ includes optional [D] siloxy units (i.e., those siloxy units in each moiety indicated by subscript m) as well as an [M] siloxy unit (i.e., represented by OSiR²₃). As such, when each R³ is of formula —OSi(R⁴)₃ and each R⁴ is of formula —[OSiR²₂]ₘOSiR²₃, then each R³ includes a [Q] siloxy unit. More specifically, in such embodiments, each R³ is of formula —OSi([OSiR²₂]ₘOSiR²₃)₃, such that when each subscript m is 0, each R³ is a [Q] siloxy unit endcapped with three [M] siloxy units. Likewise, when subscript m is greater than 0, each R³ includes a linear moiety (i.e., a diorganosiloxane moiety) with a degree of polymerization being attributable to subscript m.

As set forth above, each R⁴ can also be of formula —OSi(R⁵)₃. In embodiments where one or more R⁴ is of formula —OSi(R⁵)₃, further branching can be present in the siloxane moiety Z¹ depending a selection of R⁵. More specifically, each R⁵ is selected from R², —OSi(R⁶)₃, and —[OSiR²₂]ₘOSiR²₃, where each R⁶ is selected from R² and —[OSiR²₂]ₘOSiR²₃, and where each subscript m is defined above.

Subscript m is from (and including) 0 to 100, alternatively from 0 to 80, alternatively from 0 to 60, alternatively from 0 to 40, alternatively from 0 to 20, alternatively from 0 to 19, alternatively from 0 to 18, alternatively from 0 to 17, alternatively from 0 to 16, alternatively from 0 to 15, alternatively from 0 to 14, alternatively from 0 to 13, alternatively from 0 to 12, alternatively from 0 to 11, alternatively from 0 to 10, alternatively from 0 to 9, alternatively from 0 to 8, alternatively from 0 to 7, alternatively from 0 to 6, alternatively from 0 to 5, alternatively from 0 to 4, alternatively from 0 to 3, alternatively from 0 to 2, alternatively from 0 to 1, alternatively is 0. In certain embodiments, each subscript m is 0, such that the siloxane moiety Z¹ is free from D siloxy units.

Importantly, each of R², R³, R⁴, R⁵, and R⁶ are independently selected. As such, the descriptions above relating to each of these substituents is not meant to mean or imply that each substituent is the same. Rather, any description above relating to R⁴, for example, may relate to only one R⁴ or any number of R⁴ in the siloxane moiety Z¹, and so on. In addition, different selections of R², R³, R⁴, R⁵, and R⁶ can result in the same structures. For example, if R³ is —OSi(R⁴)₃, and if each R⁴ is —OSi(R⁵)₃, and if each R⁵ is R², then R³ can be written as —OSi(OSiR²₃)₃. Similarly, if R³ is —OSi(R⁴)₃, and if each R⁴ is —[OSiR²₂]ₘOSiR²₃, R³ can be written as —OSi(OSiR²₃)₃ when subscript m is 0. As shown, these particular selections result in the same final structure for R³, based on different selections for R⁴. To that end, any proviso of limitation on final structure of the siloxane moiety Z¹ is to be considered met by an alternative selection that results in the same structure required in the proviso.

In certain embodiments, each R² is an independently selected alkyl group. In some such embodiments, each R² is an independently selected alkyl group having from 1 to 10, alternatively from 1 to 8, alternatively from 1 to 6, alternatively from 1 to 4, alternatively from 1 to 3, alternatively from 1 to 2 carbon atom(s).

In particular embodiments, each subscript m is 0 and each R² is methyl, and the siloxane moiety Z¹ has one of the following structures (i)-(iv):

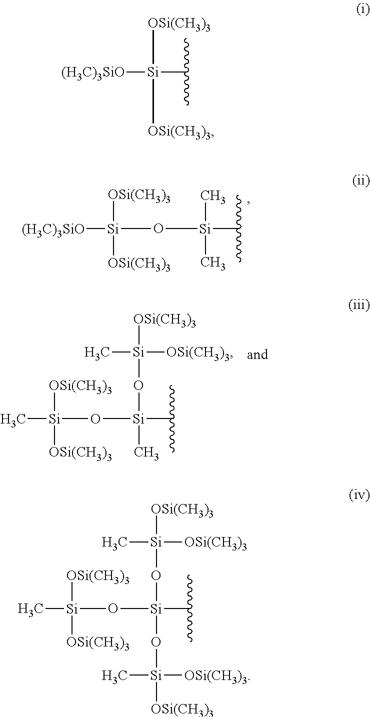

With further regard to the cationic surfactant and formula (I), as introduced above, D¹ a divalent linking group. The divalent linking group D¹ is not particularly limited. Typically, divalent linking group D¹ is selected from divalent hydrocarbon groups. Examples of such hydrocarbon groups include divalent forms of the hydrocarbyl and hydrocarbon groups described above, such as any of those set forth above with respect to R^{x}. As such, it will be appreciated that suitable hydrocarbon groups for the divalent linking group D¹ may be substituted or unsubstituted, and linear, branched, and/or cyclic.

In some embodiments, divalent linking group D¹ comprises, alternatively is a linear or branched alkyl and/or alkylene group. In certain embodiments, divalent linking group D¹ comprises, alternatively is, a C₁-C₁₈ hydrocarbon moiety, such as a linear hydrocarbon moiety having the formula —(CH₂)_{d}—, where subscript d is from 1 to 18. In some such embodiments, subscript d is from 1 to 16, such as from 1 to 12, alternatively from 1 to 10, alternatively from 1 to 8, alternatively from 1 to 6, alternatively from 2 to 6, alternatively from 2 to 4. In particular embodiments, subscript d is 3, such that divalent linking group D¹ comprises a propylene (i.e., a chain of 3 carbon atoms). As will be appreciated by those of skill in the art, each unit represented by subscript d is a methylene unit, such that linear hydrocarbon moiety may be defined or otherwise referred to as an alkylene group. It will also be appreciated that each methylene group may independently be unsubstituted and unbranched, or substituted (e.g. with a hydrogen atom replaced with a non-hydrogen atom or group) and/or branched (e.g. with a hydrogen atom replaced with an alkyl group). In certain embodiments, divalent linking group D¹ comprises, alternatively is, an unsubstituted alkylene group. In other embodiments, divalent linking group D¹ comprises, alternatively is, a substituted hydrocarbon group, such as a substituted alkylene group. In such embodiments, for example, divalent linking group D¹ typically comprises a carbon backbone having at least 2 carbon atoms and at least one heteroatom (e.g. O, N, S, etc.), such that the backbone comprises an ether moiety, amine moiety, etc.

In particular embodiments, divalent linking group D¹ comprises, alternatively is, an amino substituted hydrocarbon group (i.e., a hydrocarbon comprising a nitrogen-substituted carbon chain/backbone). For example, in some such embodiments, the divalent linking group D¹ is an amino substituted hydrocarbon having formula -D³-N(R⁷)-D³-, such that the siloxane cationic surfactant (B) may be represented by the following formula:

[Z¹-D³-N(R⁷)-D³-N(Y)ₐ(R)₂₋ₐ]^{+y}[X^{-X}]ₙ,

where each D³ is an independently selected divalent linking group, Z¹ is as defined and described above, R⁷ is Y or H, and each Y, R, subscript a, X, superscript y, superscript x, and subscript n is as defined above and described below.

As introduced above, each D³ of the amino substituted hydrocarbon divalent linking group is independently selected. Typically, each D³ comprises an independently selected alkylene group, such as any of those described above with respect to divalent linking group D¹. For example, in some embodiments, each D³ is independently selected from alkylene groups having from 1 to 8 carbon atoms, such as from 2 to 8, alternatively from 2 to 6, alternatively from 2 to 4 carbon atoms. In certain embodiments, each D³ is propylene (i.e., —(CH₂)₃—). However, it is to be appreciated that one or both D³ may be, or comprise, another divalent linking group (i.e., aside from the alkylene groups described above). Moreover, each D³ may be substituted or unsubstituted, linear or branched, and various combinations thereof.

As also introduced above, R⁷ of the amino substituted hydrocarbon is H or quaternary ammonium moiety Y (i.e., of formula -D-NR¹₃_{⁺}, as set forth above). For example, in particular embodiments, R⁷ H, such that the siloxane cationic surfactant (B) may be represented by the following formula:

[Z¹-D³-NH-D³-N(Y)ₐ(R)₂₋ₐ]^{+y}[X^{-x}]ₙ,

where each D³ and Z¹ is as defined and described above and each Y, R, subscript a, X, superscript y, superscript x, and subscript n is as defined above and described below. In such embodiments, as will be appreciated from the further description below, superscript y is 1 or 2, controlled by subscript a. More particularly, the number of quaternary ammonium moieties Y will be controlled by subscript a as 1 or 2, providing a total cationic charge of +1 or +2, respectively. Accordingly, in such embodiments, superscript x will also be 1 or 2, such that the siloxane cationic surfactant (B) will be charge balanced.

In certain embodiments, R⁷ of the amino substituted hydrocarbon is the quaternary ammonium moiety Y, such that the siloxane cationic surfactant (B) may be represented by the following formula:

[Z¹-D³-NY-D³-N(Y)ₐ(R)₂₋ₐ]^{+y}[X^{-X}]ₙ,

where each D³ and Z¹ is as defined and described above and each Y, R, subscript a, X, superscript y, superscript x, and subscript n is as defined above and described below. In such embodiments, y=a+1, such that superscript y is 2 or 3. More particularly, the number of quaternary ammonium moieties will include the Y of R⁷ as well as the 1 or 2 quaternary ammonium moiety Y controlled by subscript a, providing a total cationic charge of +2 or +3, respectively. Accordingly, in such embodiments, superscript x will be 1, 2, or 3, such that the siloxane cationic surfactant (B) will be charge balanced.

In some embodiments, R⁷ is Y and the siloxane moiety Z¹ is the branched siloxane moiety described above, such that the siloxane cationic surfactant (B) may be represented by the following formula:

[(R³)₃Si-D³-N(-D-NR¹₃_{⁺})-D³-N(-D-NR¹₃_{⁺})ₐ(R)₂₋ₐ]^{+y}[X^{-X}]ₙ,

where each D³ and R³ is as defined and described above, and each D, R, R¹, subscript a, X, superscript y, superscript x, and subscript n is as defined above and described below.

Subscript a is 1 or 2. As will be appreciated by those of skill in the art, subscript a indicates whether the quaternary ammonium-substituted amino moiety of the siloxane cationic surfactant (B) represented by subformula —N(Y)ₐ(R)₂₋ₐ has one or two of quaternary ammonium groups Y (i.e., the group of subformula (-D-NR¹₃_{⁺}). Likewise, as each such quaternary ammonium groups Y, subscript a also indicates the number of counter anions (i.e., number of anions X, as described below) required to balance out the cationic charge from the quaternary ammonium groups Y indicated by moieties a. For example, in some embodiments, subscript a is 1, and the siloxane cationic surfactant (B) has the following formula:

[Z¹-D¹-N(R)-D-NR¹₃]^{+y}[X^{-x}]ₙ,

where Z¹ and D¹ are as defined and described above, and each D, R, R¹, X, superscript y, superscript x, and subscript n is as defined above and described below.

It is to be appreciated that, while subscript a is 1 or 2 in each cationic molecule of the siloxane cationic surfactant (B), the siloxane cationic surfactant (B) may comprise a mixture of cationic molecules that correspond to formula (I) but are different from one another (e.g. with respect to subscript a). As such, while subscript a is 1 or 2, a mixture comprising the siloxane cationic surfactant (B) may have an average value of a of from 1 to 2, such as an average value of 1.5 (e.g. from a 50:50 mixture of cationic molecules of the siloxane cationic surfactant (B) where a=1 and molecules of the siloxane cationic surfactant (B) where a=2.

Each R independently represents H or an unsubstituted hydrocarbyl group having from 1 to 4 carbon atoms, when present (e.g. when subscript a is 1). In some embodiments, R is H. In other embodiments, R an alkyl group having from 1 to 4 carbon atoms, such as from 1 to 3, alternatively from 1 to 2 carbon atom(s). For example, R may be a methyl group, an ethyl group, a propyl group (e.g. an n-propyl or iso-propyl group), or a butyl group (e.g. an n-butyl, sec-butyl, iso-butyl, or tert-butyl group). In certain embodiments, each R is methyl.

Each R¹ represents an independently selected unsubstituted hydrocarbyl group having from 1 to 4 carbon atoms. For example, in certain embodiments, each R¹ is independently selected from alkyl groups having from 1 to 4 carbon atoms, such as from 1 to 3, alternatively from 1 to 2 carbon atom(s). In such embodiments, each R¹ is typically selected from methyl groups, ethyl groups, propyl groups (e.g. n-propyl and iso-propyl groups), and butyl group (e.g. n-butyl, sec-butyl, iso-butyl, and tert-butyl groups). While independently selected, in certain embodiments each R¹ is the same as each other R¹ in the cationic surfactant. For example, in certain embodiments, each R¹ is methyl or ethyl. In specific embodiments, each R¹ is methyl.

Each D represents an independently selected divalent linking group (“linking group D”). Typically, linking group D is selected from substituted and unsubstituted divalent hydrocarbon groups. Examples of such hydrocarbon groups include divalent forms of the hydrocarbyl and hydrocarbon groups described above, such as any of those set forth above with respect to R^{x}, D¹, and D³. As such, it will be appreciated that suitable hydrocarbon groups for use in or as linking group D may be linear or branched, and may be the same as or different from any other divalent linking group.

In certain embodiments, linking group D comprises an alkylene group, such as one of those described above with respect to divalent linking group D¹. For example, in certain embodiments, linking group D comprises an alkylene group having from 1 to 8 carbon atoms, such as from 1 to 6, alternatively from 2 to 6, alternatively from 2 to 4 carbon atoms. In some such embodiments, the alkylene group of linking group D is unsubstituted. Examples of such alkylene groups include methylene groups, ethylene groups, propylene groups, butylene groups, etc.

In certain embodiments, linking group D comprises, alternatively is, a substituted hydrocarbon group, such as a substituted alkylene group. In such embodiments, for example, linking group D typically comprises a carbon backbone having at least 2 carbon atoms, and at least one heteroatom (e.g. O) in the backbone or bonded to one of the carbon atoms thereof (e.g. as a pendant substituent). For example, in some embodiments, linking group D comprises a hydroxyl-substituted hydrocarbon having formula -D′-CH(—(CH₂)ₑ—OH)-D′-, where each D′ is independently a covalent bond or a divalent linking group, and subscript e is 0 or 1. In such embodiments, at least one D′ typically comprises an independently selected alkylene group, such as any of those described above. For example, in some embodiments, each D′ is independently selected from alkylene groups having from 1 to 8 carbon atoms, such as from 1 to 6, alternatively from 1 to 4, alternatively from 1 to 2 carbon atoms. In certain embodiments, each D′ is methylene (i.e., —CH₂—). However, it is to be appreciated that one or both D′ may be, or comprise, another divalent linking group (i.e., aside from the alkylene groups described above).

In some embodiments, each linking group D is an independently selected hydroxypropylene group (i.e., where each D′ is an independently selected from the covalent bond and methylene, with the provisos that at least one D′ is the covalent bond when subscript e is 1, and each D′ is methylene when subscript e is 0). Accordingly, in some such embodiments, each linking group D is independently of one of the following formulas:

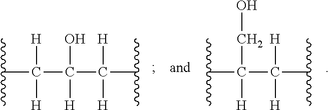 [SMILES: *CC(O)C* ; *CC(*)CO]

In some embodiments, siloxane moiety Z¹ is the branched siloxane moiety, divalent linking group D is the amino substituted hydrocarbon where each D³ is propylene and R⁷ is H, subscript a is 1, R is H, each linking group D is a (2-hydroxy)propylene group, each R¹ is methyl, and X is a monoanion, such that the siloxane cationic surfactant (B) has the following formula:

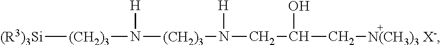

where each R³ is as defined and described above, and X is as defined above and described below. In other embodiments, the siloxane cationic surfactant (B) is configured the same as described immediately above, but with subscript a=2, such that the siloxane cationic surfactant (B) has the following formula:

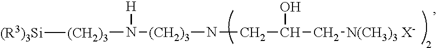

where each R³ is as defined and described above, and each X is as defined above and described below. In other embodiments, the siloxane cationic surfactant (B) is configured the same as described immediately above, but with R⁷ being the quaternary ammonium moiety Y, such that the siloxane cationic surfactant (B) has the following formula:

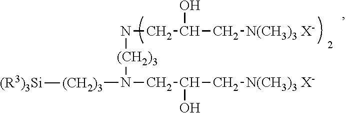

where each R³ is as defined and described above, and each X is as defined above and described below. In yet other embodiments, the siloxane cationic surfactant (B) is configured the same as described immediately above, but with subscript a=1 and R being H, such that the siloxane cationic surfactant (B) has the following formula:

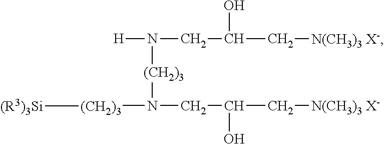

where each R³ is as defined and described above, and each X is as defined above and described below.

Each X is an anion having a charge represented by superscript x. Accordingly, as will be understood by those of skill in the art, X is not particularly limited and may be any anion suitable for ion-pairing/charge-balancing one or more cationic quaternary ammonium moieties Y. As such, each X may be an independently selected monoanion or polyanion (e.g. dianion, etc.), such that one X may be sufficient to counterbalance two or more cationic quaternary ammonium moieties Y. As such, the number of anions X (i.e., subscript n) will be readily selected based on the number of cationic quaternary ammonium moieties Y and the charge of X selected (i.e., superscript x).

Examples of suitable anions include organic anions, inorganic anions, and combinations thereof. Typically, each anion X is independently selected from monoanions that are unreactive the other moieties of the cationic surfactant. Examples of such anions include conjugate bases of medium and strong acids, such as halide ions (e.g. chloride, bromide, iodide, fluoride), sulfates (e.g. alkyl sulfates, etc.), sulfonates (e.g. triflates, benzyl or other aryl sulfonates, etc.), and the like, as well as derivatives, modifications, and combinations thereof. Other anions may also be utilized, such as phosphates, nitrates, organic anions such as carboxylates (e.g. acetates), and the like, as well as derivatives, modifications, and combinations thereof. It is to be appreciated that derivatives of such anions include polyanionic compounds comprising two or more functional groups for which the above examples are named. For example, mono and/or polyanions of polycarboxylates (e.g. citric acid, etc.) are encompassed by the anions above. Other examples of anions include tosylate anions, bis(trifluoromethanesulfonyl)imide anions, bis(fluorosulfonyl)imide anions, hexafluorophosphate anions, tetrafluoroborate anions, and the like, as well as derivatives, modifications, and combinations thereof.

In certain embodiments, each anion X is an inorganic anion having one to three valences. Examples of such anions include monoanions such as chlorine, bromine, iodine, aryl sulfonates having six to 18 carbon atoms, nitrates, nitrites, and borate anions, dianions such as sulfate and sulfite, and trianions such as phosphate. In certain embodiments, each X is a halide anion. In some such embodiments, each X is chloride (i.e., Cl⁻).

In specific embodiments, component (B) has at least one of the following formulas:

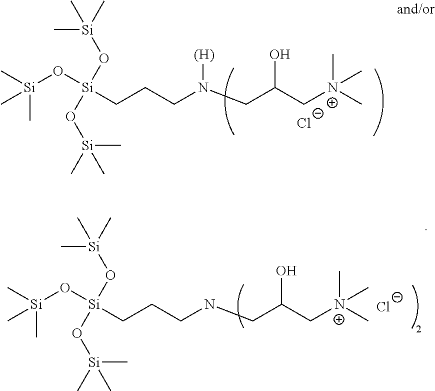

The siloxane cationic surfactant (B) may comprise a combination or two or more different siloxane cationic surfactants represented by general formula (I) above that differ in at least one property such as structure, molecular weight, degree of branching, silicon and/or carbon content, number of cationic quaternary ammonium groups Y (e.g. when subscript a represents an average value), etc.

The siloxane cationic surfactant (B) may be utilized in any amount in the composition, depending on the form of the composition prepared, a desired use thereof, other components present therein, etc. For example, one of skill in the art will appreciate that, when the composition is formulated as a concentrate, the siloxane cationic surfactant (B) will be present in higher relative amounts as compared to non-concentrated forms (e.g. aqueous foam compositions). As such, the siloxane cationic surfactant (B) may be present in the composition in any amount, such as an amount of from 0.001 to 60 wt. %, based on the total weight of the composition (i.e., wt./wt.). Typically, the composition comprises the siloxane cationic surfactant (B) in an amount sufficient to provide an end-use composition (i.e., any fully formulated composition comprising the foam stabilizing composition ready for a use) with from 0.01 to 1 wt. % of the siloxane cationic surfactant (B), based on the total weight of the end-use composition (i.e., an active amount of component (A) of from 0.01 to 1 wt. %). For example, in certain embodiments, component (A) is utilized in an active amount of from 0.05 to 1 wt. %, such as from 0.1 to 0.9, alternatively from 0.1 to 0.7, alternatively from 0.1 to 0.5, alternatively from 0.1 to 0.4, alternatively from 0.15 to 0.4, alternatively from 0.2 to 0.4 wt. %, based on the total weight of the composition, or an end-use composition comprising the same.

At least one of the following provisos is true with respect to the composition: (i) components (A) and (B) are present in the composition in a weight ratio of from 0.5:1 to 3.5:1 (A)/(B); and/or (ii) components (A) and (B) are present in the composition to provide a molar ratio of anionic groups in component (A) to cationic groups in component (B) of from 1:1 to 6.5:1.

In certain embodiments, proviso (i) is true, i.e., components (A) and (B) are present in the foam stabilizing composition in a weight ratio of from 0.5:1 to 3.5:1 (A)/(B).

In other embodiments, proviso (ii) is true, i.e., components (A) and (B) are present in the foam stabilizing composition to provide a molar ratio of anionic groups in component (A) to cationic groups in component (B) of from 1:1 to 6.5:1.

In yet other embodiments, both of provisos (i) and (ii) are true.

In certain embodiments, the composition further comprises (C) a stability enhancer other than component (B). The stability enhancer (C) typically includes at least one cationic moiety and/or nonionic moiety, alternatively component (C) is cationic or nonionic. In some embodiments, the stability enhancer (C) comprises, alternatively is, an amphiphilic compound. In certain embodiments, the stability enhancer (C) may be surface active and referred to as an amphiphilic surfactant. In other embodiments, the stability enhancer (C) is not surface active and is not amphiphilic. In yet other embodiments, the stability enhancer (C) comprises is cationic and optionally includes a counter anion. Combinations of surface active and non-surface active compounds can be used together as component (C). In certain embodiments, the stability enhancer (C) is not a siloxane surfactant, i.e., component (C) is free from siloxane bonds.

When the stability enhancer (C) is cationic, one specific example of the stability enhancer (C) is an organic cationic surfactant, i.e., a complex comprising a cationic quaternary organoammonium compound charge-balanced with a counter ion. In particular, the organic cationic surfactant can comprise a hydrocarbon moiety and one or more quaternary ammonium moieties, and conforms to general formula (II):

[Z²-D²-N(Y)_{b}(R)_{2-b}]^{+y}[X^{-x}]ₙ (II),

wherein Z² is a substituted or unsubstituted hydrocarbyl group or a functional group; D² is a covalent bond or a divalent linking group; subscript b is 1 or 2; and each R, Y, superscript y, X, subscript n, and superscript x is independently selected and as defined above.

With regard to the organic cationic surfactant and formula (II), each R, Y, superscript y, X, subscript n, and superscript x is independently selected and as defined above with respect to the siloxane cationic surfactant (B). As such, while specific selections are exemplified below with regard to these variables in formula (II) representing the organic cationic surfactant, it will be appreciated that such selections are not limiting, but rather that all description of R, Y, superscript y, X, subscript n, and superscript x, as well as variables thereof (e.g. divalent linking group D of quaternary ammonium moieties Y, groups D and subscripts e of divalent linking groups D, etc.).

Z² is a substituted or unsubstituted hydrocarbyl group, or a functional group, and is otherwise not particularly limited. Examples of suitable such hydrocarbyl moieties include the unsubstituted monovalent hydrocarbon moieties described above with respect to R^{x}. As such, it will be appreciated that Z² may comprise, alternatively may be, linear, branched, cyclic, or combinations thereof. Likewise, the Z² may comprise aliphatic unsaturation, including ethylenic and/or acetylenic unsaturation (i.e., C—C double and/or triple bonds, otherwise known as alkenes and alkynes, respectively). Z² may comprise but one such unsaturated group or, alternatively, may comprise more than one unsaturated group, which may be nonconjugated, or conjugated (e.g. when Z² comprises a diene, a ene-yne, diyne, etc.) and/or aromatic (e.g. when Z² comprises a phenyl group, benzyl group, etc.).

In some embodiments, Z² is an unsubstituted hydrocarbyl moiety having from 5 to 20 carbon atoms. In certain such embodiments, Z² comprises, alternatively is, an alkyl group. Suitable alkyl groups include saturated alkyl groups, which may be linear, branched, cyclic (e.g. monocyclic or polycyclic), or combinations thereof. Examples of such alkyl groups include those having the general formula C_{f}H_{2-2g+1}, where subscript f is from 5 to 20 (i.e., the number of carbon atoms present in the alkyl group), subscript g is the number of independent rings/cyclic loops, and at least one carbon atom designated by subscript f is bonded to group D² in general formula (II) above. Examples of linear and branched isomers of such alkyl groups (i.e., where the alkyl group is free from cyclic groups such that subscript f=0), include those having the general formula C_{f}H_{2f+1}, where subscript f is as defined above and at least one carbon atom designated by subscript f is bonded to group D² in general formula (II) above. Examples of monocyclic alkyl groups include those having the general formula C_{f}H_{2f-1}, where subscript f is as defined above and at least one carbon atom designated by subscript f is bonded to group D² in general formula (II) above.

Specific examples of such alkyl groups include pentyl groups, hexyl groups, heptyl groups, octyl groups, nonyl groups, decyl groups, undecyl groups dodecyl groups, tridecyl groups, tetradecyl groups, pentadecyl groups, hexadecyl groups, heptadecyl groups, octadecyl groups, nonadecyl groups, and eicosyl groups, including linear, branched, and/or cyclic isomers thereof. For example, pentyl groups encompass n-pentyl (i.e., a linear isomer) and cyclopentyl (i.e., a cyclic isomer), as well as branched isomers such as isopentyl (i.e., 3-methylbutyl), neopentyl (i.e., 2,2-dimethylpropy), tert-pentyl (i.e., 2-methylbutan-2-yl), sec-pentyl (i.e., pentan-2-yl), sec-isopentyl (i.e., 3-methylbutan-2-yl) etc.), 3-pentyl (i.e., pentan-3-yl), and active pentyl (i.e., 2-methylbutyl).

In certain embodiments, Z² comprises, alternatively is, an unsubstituted linear alkyl group of formula —(CH₂)_{f-1} CH₃, where subscript f is from 5 to 20 as described above. In some such embodiments, Z² is such an unsubstituted linear alkyl group, where subscript f is from 7 to 19, such that Z² is an unsubstituted linear alkyl group having from 6 to 18 carbon atoms. In certain such embodiments, subscript b is 7, 9, 11, or 13, such that Z² is an unsubstituted linear alkyl group having 6, 8, 10, or 12 carbon atoms, respectively.

On specific example of a substituted hydrocarbyl group suitable for Z² is an alkoxy or aryloxy group. Examples of alkoxy groups include methoxy, ethoxy, propoxy, butoxy, benzyloxy, and the like, as well as derivatives and modifications thereof. Examples of aryloxy groups include phenoxy, tolyloxy, pentafluorophenoxy, and the like, as well as derivatives and modifications thereof.

In some embodiments, functional groups suitable for Z² are selected from acryloxy groups, acryl groups, acrylate groups, alcohol groups, benzene groups, epoxy groups, amino groups, cyano groups, thiol groups, cycloalkyl groups, alkyl groups, nitrogen containing groups, sulfur containing groups, oxygen containing group, phosphorous containing groups, and any combination thereof. In specific embodiments, Z² is selected from an ethylenically unsaturated group, an alkyl group, an alkoxy group, an acryloxy group, an acryloyl group, and combinations thereof. One specific example of a compound suitable for component (C) when Z² is an acryl group is (3-methacrylamidopropyl) trimethylammonium chloride.

Subscript b is 1 or 2. As will be appreciated by those of skill in the art in view of the description relating to subscript a of the siloxane cationic surfactant (B), subscript b indicates whether the quaternary ammonium-substituted amino moiety of the organic cationic surfactant represented by subformula —N(Y)_{b}(R)_{2-b} has one or two of quaternary ammonium groups Y (i.e., the group of subformula (-D-NR¹₃_{⁺}). Likewise, as each such quaternary ammonium groups Y, subscript b also indicates the number of counter anions (i.e., number of anions X, as described below) required to balance out the cationic charge from the quaternary ammonium groups Y indicated by moieties b.

It is to be appreciated that, while subscript b is 1 or 2 in each cationic molecule of the organic cationic surfactant, the organic cationic surfactant may comprise a mixture of cationic molecules that correspond to formula (II) but are different from one another (e.g. with respect to subscript b). As such, while subscript b is 1 or 2, a mixture comprising the organic cationic surfactant may have an average value of b of from 1 to 2, such as an average value of 1.5 (e.g. from a 50:50 mixture of cationic molecules of the organic cationic surfactant where b=1 and molecules of the organic cationic surfactant where b=2.

With further regard to the organic cationic surfactant and formula (II), as introduced above, D² represents a covalent bond or a divalent linking group. For clarity and ease of reference, with respect to specific embodiments below, D² may be referred to more particularly as the “covalent bond D²” or “divalent linking group D²”, e.g. when D² is the covalent bond or the divalent linking group, respectively. Both selections are described and illustrated in certain embodiments below.

In certain embodiments, D² is the covalent bond (i.e., the organic cationic surfactant comprises the covalent bond D²), such that Z² is bonded directly to the amino N atom. In these embodiments, the organic cationic surfactant may be represented by the following formula:

[Z²—N(Y)_{b}(R)_{2-b}]^{+y}[X^{-x}]ₙ,

where each Z², Y, R, X, subscript b, superscript y, superscript x, and subscript n are as defined and described above. In some such embodiments, Z² is an alkyl group bonded directly to the amino N atom of the organic cationic surfactant, such that the organic cationic surfactant has the following formula:

[(C_{f}H_{2f+1})—N(Y)_{b}(R)_{2-b}]^{+y}[X^{-X}]ₙ,

where subscript b, subscript f, Y, R, X, superscript y, superscript x, and subscript n are as defined and described above. In some such embodiments, subscript f is from 6 to 18, such as from 6 to 14, alternatively from 6 to 12.

In certain embodiments, D² is the divalent linking group bond (i.e., the organic cationic surfactant comprises the divalent linking group D²). The divalent linking group D¹ is not particularly limited, and is generally selected from the same groups described above with respect to divalent linking group D¹. Accordingly, divalent linking group D² is typically selected from divalent hydrocarbon groups. Examples of such hydrocarbon groups include divalent forms of the hydrocarbyl and hydrocarbon groups described above, such as any of those set forth above with respect to R^{x}. As such, it will be appreciated that suitable hydrocarbon groups for the divalent linking group D² may be substituted or unsubstituted, linear, branched, and/or cyclic, and the same or different from any other linking group in the organic cationic surfactant and/or the siloxane cationic surfactant (B).

In some embodiments, divalent linking group D² comprises, alternatively is a linear or branched alkyl and/or alkylene group. In certain embodiments, divalent linking group D² comprises, alternatively is, a C₁-C₁₈ hydrocarbon moiety, such as the linear hydrocarbon moiety having the formula —(CH₂)_{d}—, defined above with respect to D¹ (i.e., where subscript d is from 1 to 18). In some such embodiments, subscript d is from 1 to 16, such as from 1 to 12, alternatively from 1 to 10, alternatively from 1 to 8, alternatively from 1 to 6, alternatively from 2 to 6, alternatively from 2 to 4. In particular embodiments, subscript d is 3, such that divalent linking group D² comprises a propylene (i.e., a chain of 3 carbon atoms). It will also be appreciated that each alkyl and/or alkylene group suitable for D² may independently be unsubstituted and unbranched, or substituted and/or branched. In certain embodiments, divalent linking group D² comprises, alternatively is, an unsubstituted alkylene group. In other embodiments, divalent linking group D² comprises, alternatively is, a substituted hydrocarbon group, such as a substituted alkylene group. In such embodiments, for example, divalent linking group D² typically comprises a carbon backbone having at least 2 carbon atoms and at least one heteroatom (e.g. O, N, S, etc.), such that the backbone comprises an ether moiety, amine moiety, etc.

In particular embodiments, divalent linking group D² comprises, alternatively is, an amino substituted hydrocarbon group (i.e., a hydrocarbon comprising a nitrogen-substituted carbon chain/backbone). For example, in some such embodiments, the divalent linking group D² is an amino substituted hydrocarbon having formula -D⁴-N(R⁸)-D⁴-, such that the organic cationic surfactant may be represented by the following formula:

[Z²-D⁴-N(R⁸)-D⁴-N(Y)_{b}(R)_{2-b}]^{+y}[X^{-X}]ₙ,

where each D⁴ is an independently selected divalent linking group, R⁸ is Y or H, and each Z², Y, R, subscript b, X, superscript y, superscript x, and subscript n is as defined and described above.

As introduced above, each D⁴ of the amino substituted hydrocarbon divalent linking group is independently selected. Typically, each D⁴ comprises an independently selected alkylene group, such as any of those described above with respect to divalent linking group D³ of the siloxane cationic surfactant (B). For example, in some embodiments, each D⁴ is independently selected from alkylene groups having from 1 to 8 carbon atoms, such as from 2 to 8, alternatively from 2 to 6, alternatively from 2 to 4 carbon atoms. In certain embodiments, each D⁴ is propylene (i.e., —(CH₂)₃—). However, it is to be appreciated that one or both D⁴ may be, or comprise, another divalent linking group (i.e., aside from the alkylene groups described above). Moreover, each D⁴ may be substituted or unsubstituted, linear or branched, and various combinations thereof.

As also introduced above, R⁸ of the amino substituted hydrocarbon is H or quaternary ammonium moiety Y (i.e., of formula -D-NR¹₃_{⁺}, as set forth above). For example, in particular embodiments, R⁸ H, such that the organic cationic surfactant may be represented by the following formula:

[Z²-D⁴-NH-D⁴-N(Y)_{b}(R)_{2-b}]^{+y}[X^{-X}]ₙ,

where each Z², D⁴, Y, R, subscript b, X, superscript y, superscript x, and subscript n is as defined and described above. In such embodiments, as will be appreciated from the further description below, superscript y is 1 or 2, controlled by subscript b. More particularly, the number of quaternary ammonium moieties Y will be controlled by subscript b as 1 or 2, providing a total cationic charge of +1 or +2, respectively. Accordingly, in such embodiments, superscript x will also be 1 or 2, such that the organic cationic surfactant will be charge balanced.

In certain embodiments, R⁸ is Y, such that the organic cationic surfactant may be represented by the following formula:

[Z²-D⁴-NY-D⁴-N(Y)_{b}(R)_{2-b}]^{+y}[X^{-X}]ₙ,

where each Z², D⁴, Y, R, subscript b, X, superscript y, superscript x, and subscript n is as defined and described above. In such embodiments, y=b+1, such that superscript y is 2 or 3. More particularly, the number of quaternary ammonium moieties will include the Y of R⁸ as well as the 1 or 2 quaternary ammonium moiety Y controlled by subscript b, providing a total cationic charge of +2 or +3, respectively. Accordingly, in such embodiments, superscript x will be 1, 2, or 3, such that the organic cationic surfactant will be charge balanced. For example, in some such embodiments, subscript b is 1 and X is monoanionic, such that the organic cationic surfactant has the following formula:

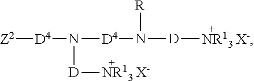

where each Z², D⁴, R, R¹, and X is as defined and described above. In other such embodiments, the organic cationic surfactant is configured as described immediately above, but with b=2, such that the organic cationic surfactant has the following formula:

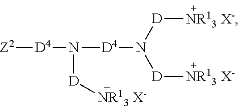

where each Z², D⁴, R, R¹, and X is as defined and described above.

In certain embodiments, D² is the covalent bond, Z² is the linear alkyl group, subscript b is 1, R is H, each linking group D is a (2-hydroxy)propylene group, each R¹ is methyl, and X is a monoanion, such that the organic cationic surfactant has the following formula:

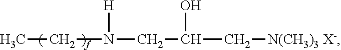

where subscript f is from 5 to 17 (e.g. from 5 to 11, alternatively from 5 to 9), and X is as defined and described above. In other embodiments, the organic cationic surfactant is configured the same as described immediately above, but with subscript b=2, such that the organic cationic surfactant has the following formula:

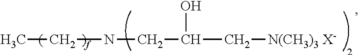

where each X is as defined above and described below.

In certain embodiments, Z² is a linear alkyl group having from 3 to 13 carbon atoms, D² the divalent linking group and the divalent linking group D² is the amino substituted hydrocarbon where each D⁴ is propylene and R⁸ is H, subscript b is 1, R is H, each linking group D is a (2-hydroxy)propylene group, each R¹ is methyl, and X is a monoanion, such that the organic cationic surfactant has the following formula:

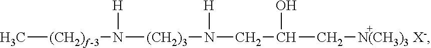

where subscript f and X are as defined and described above. In other embodiments, the organic cationic surfactant is configured the same as described immediately above, but with subscript b=2, such that the organic cationic surfactant has the following formula:

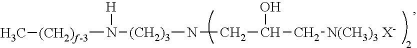

where subscript f and each X are as defined and described above. In other embodiments, the organic cationic surfactant is configured the same as described immediately above, but with R⁸ being the quaternary ammonium moiety Y, such that the organic cationic surfactant has the following formula:

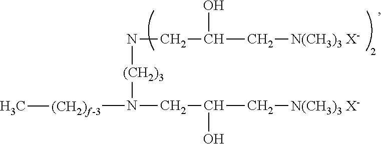

where subscript f and each X are as defined and described above. In yet other embodiments, the organic cationic surfactant is configured the same as described immediately above, but with subscript b=1 and R being H, such that the organic cationic surfactant has the following formula:

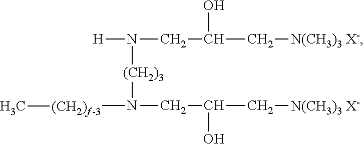

where subscript f and each X are as defined and described above.

In certain embodiments, each anion X of the organic cationic surfactant is an inorganic anion having one to three valences. Examples of such anions include monoanions such as chlorine, bromine, iodine, aryl sulfonates having six to 18 carbon atoms, nitrates, nitrites, and borate anions, dianions such as sulfate and sulfite, and trianions such as phosphate. In certain embodiments, each X is a halide anion. In some such embodiments, each X is chloride (i.e., Cl⁻). When the stability enhancer (C) comprises a cationic moiety or is cationic, another specific example of the stability enhancer (C) is an organic cationic surfactant, i.e., a complex comprising a cationic nitrogen-containing compound charge balanced with a counter ion. In particular, the organic cationic surfactant can comprise several substituted or unsubstituted hydrocarbon moieties. In certain embodiments, the stability enhancer (C) has the general formula (III):

[(Z²-D²)_{c}-N⁺(R)_{4-c}]^{+y}[X^{-x}]ₙ (III),

wherein Z² is as described; D² is as described above; subscript c is 0, 1, 2, 3, or 4; and each R, superscript y, X, subscript n, and superscript x is independently selected and as defined above.

With regard to general formula (III), each R, superscript y, X, subscript n, and superscript x is independently selected and as defined above with respect to the siloxane cationic surfactant (B) and general formula (II) of component (C). As such, while specific selections are exemplified below with regard to these variables in formula (III), it will be appreciated that such selections are not limiting, but rather that all description of R, superscript y, X, subscript n, and superscript x, as well as variables thereof, are exemplary.

Z² is described above with respect to general formula (II) of component (C).

Subscript c is 0, 1, 2, 3, or 4. As will be appreciated by those of skill in the art, subscript c will determine the relative number of R and Z² groups in component (C).

Examples of compounds represented by the general formula (III) include choline chloride, ammonium chloride, [2-(methacryloyloxy)ethyl]trimethylamfmonium chloride, benzyltriethylammonium chloride, and tributylmethylammonium chloride.

In some embodiments, the stability enhancer (C) comprises a cationic surfactant other than or in addition to the organic cationic surfactant described above. Examples of such cationic surfactants include various fatty acid amines and amides and their derivatives, and the salts of the fatty acid amines and amides. Examples of aliphatic fatty acid amines include dodecylamine acetate, octadecylamine acetate, and acetates of the amines of tallow fatty acids, homologues of aromatic amines having fatty acids such as dodecylanalin, fatty amides derived from aliphatic diamines such as undecylimidazoline, fatty amides derived from aliphatic diamines such asundecylimidazoline, fatty amides derived from disubstituted amines such as oleylaminodiethylamine, derivatives of ethylene diamine, quaternary ammonium compounds and their salts which are exemplified by tallow trimethyl ammonium chloride, dioctadecyldimethyl ammonium chloride, didodecyldimethyl ammonium chloride, dihexadecyl ammonium chloride, alkyltrimethylammonium hydroxides such as octyltrimethylammonium hydroxide, dodecyltrimethylammonium hydroxide, and hexadecyltrimethylammonium hydroxide, dialkyldimethylammonium hydroxides such as octyldimethylammonium hydroxide, decyldimethylammonium hydroxide, didodecyldimethylammonium hydroxide, dioctadecyldimethylammonium hydroxide, tallow trimethylammonium hydroxide, coconut oil, trimethylammonium hydroxide, methylpolyoxyethylene cocoammonium chloride, and dipalmitylhydroxyethylammonium methosulfate, amide derivatives of amino alcohols such as beta-hydroxylethylstearylamide, amine salts of long chain fatty acids, and the like, as well as derivatives, modifications, and combinations thereof. Alternatively, component (C) may comprise a quaternary ammonium salt, such as N-octylrimethylammonium chloride.

In these or other embodiments, the stability enhancer (C) comprises, alternatively is, a nonionic surfactant. Examples of nonionic surfactants include polyoxyethylene alkyl ethers (such as, lauryl, cetyl, stearyl or octyl), polyoxyethylene alkylphenol ethers, polyoxyethylene lauryl ethers, polyoxyethylene sorbitan monoleates, polyoxyethylene alkyl esters, polyoxyethylene sorbitan alkyl esters, polyethylene glycol, polypropylene glycol, diethylene glycol, ethoxylated trimethylnonanols, polyoxyalkylene glycol modified polysiloxane surfactants, polyoxyalkylene-substituted silicones (rake or ABn types), silicone alkanolamides, silicone esters, silicone glycosides, dimethicone copolyols, fatty acid esters of polyols, for instance sorbitol and glyceryl mono-, di-, tri- and sesqui-oleates and stearates, glyceryl and polyethylene glycol laurates; fatty acid esters of polyethylene glycol (such as polyethylene glycol monostearates and monolaurates), polyoxyethylenated fatty acid esters (such as stearates and oleates) of sorbitol, and the like, as well as derivatives, modifications, and combinations thereof.

In addition, the stability enhancer (C) may be formed in situ in the composition. For example, the stability enhancer (C) may be formed in situ by protonating an amine via an acid buffer or solution in the composition, resulting in a cationic species. For example, the amine may be a tertiary amine (e.g. N,N-diemthylhexylamine, N,N-dimethyloctylamine, and/or N,N-dimethyldecylamine), and the acid buffer may be hydrochloric acid. One of skill in the art readily understands how to protonate such an amine with an acid buffer to give a cationic species. Typically, the amine includes an alkyl group having at least 4, alternatively at least 5, alternatively at least 6, carbon atoms such that the cationic species formed in situ is amphiphilic.

The stability enhancer (C) surfactant may comprise a combination or two or more different compounds that differ in at least one property such as structure, molecular weight, degree of branching, silicon and/or carbon content, number of cationic quaternary ammonium groups, etc.

The stability enhancer (C), when utilized, may be utilized in any amount in the composition, depending on the form of the composition prepared, a desired use thereof, other components present therein, etc. For example, one of skill in the art will appreciate that, when the composition is formulated as a concentrate, the stability enhancer (C) will be present in higher relative amounts as compared to non-concentrated forms (e.g. aqueous foam compositions). As such, the stability enhancer (C) may be present in the composition in any amount, such as an amount of from 0 to 60 wt. %, based on the total weight of the composition (i.e., wt./wt.). In certain embodiments including the stability enhancer (C), the composition comprises the stability enhancer (C) in an amount to provide a weight ratio of the stability enhancer (C) to the siloxane cationic surfactant (B) of from greater than 0:1: to 10:1 (C)/(B).

It is to be appreciated that each of the siloxane cationic surfactant (B) and the organic cationic surfactant described above are independently selected when the organic cationic surfactant is utilized, and thus each variable in formulas (I) and (II), even where representing the same group/moiety and/or having the same definition, is independently selected.

The composition may comprise (D) a carrier vehicle (e.g. a solvent, diluent, dispersant, etc.). In such embodiments, the carrier vehicle (D) will be selected based on the particular components (A) and (B) selected, as well as any other components utilized in the composition and/or to be combined with the composition (i.e., in an end-use composition). Carrier vehicles are known in the art, and generally comprise solvents, fluids, oils, and the like, as well as combinations thereof. The carrier vehicle (D) may facilitate introduction of certain components into the composition, mixing and/or homogenization of the components, etc. Likewise, the particular carrier vehicle (D) will be selected based on the solubility of components (A) and (B) and/or other components utilized in the composition, the volatility (i.e., vapor pressure) of the solvent, the end-use of the composition, etc. The solubility refers to the carrier vehicle (D) being sufficient to dissolve and/or disperse components (A) and (B) to form a homogenous composition.

As such, solvents for use in the composition may generally be selected for fluidizing and/or dissolving components (A) and (B), or another component of the composition. As will be understood by those of skill in the art, while organic solvents may be utilized in the composition, such organic solvents will typically be removed before utilizing the composition, or an end-use composition comprising the same, especially if the organic solvents are flammable.

Examples of solvents include aqueous solvents, organic solvents, and combinations thereof. Examples of aqueous solvents include water and polar and/or charged (i.e., ionic) solvents compatible with water. Examples of organic solvents include those comprising an alcohol, such as methanol, ethanol, isopropanol, butanol, and n-propanol; a ketone, such as acetone, methylethyl ketone, and methyl isobutyl ketone; an aromatic hydrocarbon, such as benzene, toluene, and xylene; an aliphatic hydrocarbon, such as heptane, hexane, and octane; a glycol ether, such as propylene glycol methyl ether, dipropylene glycol methyl ether, propylene glycol n-butyl ether, propylene glycol n-propyl ether, and ethylene glycol n-butyl ether; a halogenated hydrocarbon, such as dichloromethane, 1,1,1-trichloroethane, and chloroform; dimethyl sulfoxide; dimethyl formamide, acetonitrile; tetrahydrofuran; white spirits; mineral spirits; naphtha; n-methylpyrrolidone; and the like, as well as derivatives, modifications, and combination thereof. Specific examples of such polar organic solvents generally compatible with water include methanol, ethanol, 1-propanol, 2-propanol, 2-methyl-2-propanol, 2-butanone, tetrahydrofuran, acetone, and combinations thereof.

Examples of fluids include organic fluids, silicone fluids, and combinations thereof. Organic fluids typically comprise an organic oil including a volatile and/or semi-volatile hydrocarbon, ester, and/or ether. General examples of such organic fluids include volatile hydrocarbon oils, such as C₆-C₁₆ alkanes, C₈-C₁₆ isoalkanes (e.g. isodecane, isododecane, isohexadecane, etc.), C₈-C₁₆ branched esters (e.g. isohexyl neopentanoate, isodecyl neopentanoate, etc.), and the like, as well as derivatives, modifications, and combinations thereof. Additional examples of organic fluids include aromatic hydrocarbons, aliphatic hydrocarbons, alcohols having more than 3 carbon atoms, aldehydes, ketones, amines, esters, ethers, glycols, glycol ethers, alkyl halides, aromatic halides, and combinations thereof. Hydrocarbons include isododecane, isohexadecane, Isopar L (C₁₁-C₁₃), Isopar H (C₁₁-C₁₂), hydrogentated polydecene. Ethers and esters include isodecyl neopentanoate, neopentylglycol heptanoate, glycol distearate, dicaprylyl carbonate, diethylhexyl carbonate, propylene glycol n-butyl ether, ethyl-3 ethoxypropionate, propylene glycol methyl ether acetate, tridecyl neopentanoate, propylene glycol methylether acetate (PGMEA), propylene glycol methylether (PGME), octyldodecyl neopentanoate, diisobutyl adipate, diisopropyl adipate, propylene glycol dicaprylate/dicaprate, octyl ether, octyl palmitate, and combinations thereof. Silicone fluids typically comprise a low viscosity and/or volatile siloxane. Examples of such silicone fluids include those including a low viscosity organopolysiloxane, a volatile methyl siloxane, a volatile ethyl siloxane, a volatile methyl ethyl siloxane, or the like, or combinations thereof. Typically, silicone fluids have a viscosity at 25° C. in the range of 1 to 1,000 mm²/sec. Specific examples of silicone fluids include hexamethylcyclotrisiloxane, octamethylcyclotetrasiloxane, decamethylcyclopentasiloxane, dodecamethylcyclohexasiloxane, octamethyltrisiloxane, decamethyltetrasiloxane, dodecamethylpentasiloxane, tetradecamethylhexasiloxane, hexadeamethylheptasiloxane, heptamethyl-3-{(trimethylsilyl)oxy)}trisiloxane, hexamethyl-3,3, bis{(trimethylsilyl)oxy}trisiloxane pentamethyl{(trimethylsilyl)oxy}cyclotrisiloxane as well as polydimethylsiloxanes, polyethylsiloxanes, polymethylethylsiloxanes, polymethylphenylsiloxanes, polydiphenylsiloxanes, caprylyl methicone, hexamethyldisiloxane, heptamethyloctyltrisiloxane, hexyltrimethicone, and the like, as well as derivatives, modifications, and combinations thereof. Additional examples of silicone fluids include polyorganosiloxanes with vapor pressures of from 5×10⁻⁷ to 1.5×10⁻⁶ m²/s.

Other carrier vehicles may also be utilized. For example, in some embodiments, the carrier vehicle comprises an ionic liquid. Examples of ionic liquids include anion-cation combinations. Generally, the anion is selected from alkyl sulfate-based anions, tosylate anions, sulfonate-based anions, bis(trifluoromethanesulfonyl)imide anions, bis(fluorosulfonyl)imide anions, hexafluorophosphate anions, tetrafluoroborate anions, and the like, and the cation is selected from imidazolium-based cations, pyrrolidinium-based cations, pyridinium-based cations, lithium cation, and the like. However, combinations of multiple cations and anions may also be utilized. Specific examples of the ionic liquids typically include 1-butyl-1-methylpyrrolidinium bis(trifluoromethanesulfonyl)imide, 1-methyl-1-propylpyrrolidinium bis-(trifluoromethanesulfonyl)imide, 3-methyl-1-propylpyridinium bis(trifluoromethanesulfonyl)imide, N-butyl-3-methylpyridinium bis(trifluoromethanesulfonyl)imide, 1-methyl-1-propylpyridinium bis(trifluoromethanesulfonyl)imide, diallyldimethylammonium bis(trifluoromethanesulfonyl)imide, methyltrioctylammonium bis(trifluoromethanesulfonyl)imide, 1-butyl-3-methylimidazolium bis(trifluoromethanesulfonyl)imide, 1,2-dimethyl-3-propylimidazolium bis(trifluoromethanesulfonyl)imide, 1-ethyl-3-methylimidazolium bis(trifluoromethanesulfonyl)imide, 1-vinylimidazolium.bis(trifluoromethanesulfonyl)imide, 1-allyl imidazolium bis(trifluoromethanesulfonyl)imide, 1-allyl-3-methylimidazolium bis(trifluoromethanesulfonyl)imide, lithium bis(trifluoromethanesulfonyl)imide, and the like, as well as derivatives, modifications, and combinations thereof.

In certain embodiments, the carrier vehicle (D) is an aqueous solvent, and comprises, alternatively consists essentially of, alternatively is, water. The water is not particularly limited. For example, purified water such as distilled water and ion exchanged water, saline, a phosphoric acid buffer aqueous solution, and the like, or combinations and/or modifications thereof, can be used. In some such embodiments, the carrier vehicle (D) comprises water and at least one other solvent (i.e., a co-solvent), such as a water-miscible solvent. Examples of such co-solvents may include any of the water miscible carrier vehicles described above. Particular examples of co-solvents include glycerol, sorbitol, ethylene glycol, propylene glycol, hexylene glycol, polyethylene glycol (PEG), ethers of diethylene and dipropylene glycols (e.g. methyl, ethyl, propyl, and butyl ethers, etc.), and the like, as well as derivatives, modifications, and combinations thereof.

The amount of carrier vehicle (D) utilized is not limited, and depend on various factors, including the type of solvent selected, the amount and type of components (A) and (B) employed, the form of the composition (i.e., whether a concentrate, intermediate, or end-use composition), etc. Typically, the amount of carrier vehicle (D) utilized may range from 0.1 to 99.9 wt. %, based on the total weight of the composition, or the total combined weights of components (A), (B), and (C) (if utilized). In some embodiments, the carrier vehicle (D) is utilized in an amount of from 50 to 99.9 wt. %, such as from 60 to 99.9, alternatively of from 70 to 99.9, alternatively of from 80 to 99.9, alternatively of 90 to 99.9, alternatively of from 95 to 99.9, alternatively of from 98 to 99.9, alternatively of from 98.5 to 99.9, alternatively of from 98.5 to 99.7, alternatively of from 98.7 to 99.7 wt. %, based on the combined weights of components (A), (B), and optionally (C). One of skill in the art that the upper limits of these ranges generally reflect the active amounts of components (A) and (B) utilized (i.e., in an end-use composition). As such, amounts outside these ranges may also be utilized. In specific embodiments, a weight ratio of water to component (A) is from 90:1 to 600:1.

In the composition, the anionic polymer (A) and the siloxane cationic surfactant (B) may be used alone (i.e., neat or in combination with the carrier vehicle (D)), together with at least one auxiliary component, or as an auxiliary to at least one other component, optionally in the presence of one of more additives (e.g. agents, adjuvants, ingredients, modifiers, etc.). As such, in certain embodiments, the composition further comprises one or more additional components, such as one or more additives. It is to be appreciated that such additives may be classified under different terms of art and just because an additive is classified under such a term does not mean that it is thusly limited to that function. Moreover, some of these additives may be present in a particular component of the composition, or instead may be incorporated when forming the composition. Typically, the composition may comprise any number of additives, e.g. depending on the particular type and/or function of the same in the composition.

For example, in certain embodiments, the composition may comprise one or more additive components comprising, alternatively consisting essentially of, alternatively consisting of: (E) a rheology modifier; (F) a pH control agent; and (G) a foam enhancer.

In certain embodiments, the composition further comprises the rheology modifier (E). The rheology modifier (E) is not particularly limited, and is generally selected to alter the viscosity, flow property, and/or a foaming property (i.e., foam-forming ability and/or foam stability) of the composition, or an end-use composition comprising the same. As such, the rheology modifier (E) is not particular limited, and may comprise a thickener, stabilizer, viscosity modifier, thixotropic agent, etc., or combinations thereof, which will be generally selected from natural or synthetic thickening compounds. In some embodiments, the rheology modifier (E) comprises one or more water soluble and/or water compatible thickening compounds (e.g. water-soluble organic polymers, etc.). If utilized, the rheology modifier (E) is different from the anionic polymer (A).

Examples of compounds suitable for use in or as the rheology modifier (E) include acrylamide copolymers, acrylate copolymers and salts thereof (e.g. sodium polyacrylates, etc.), celluloses (e.g. methylcelluloses, methylhydroxypropylcelluloses, hydroxyethylcelluloses, hydroxypropylcelluloses, polypropylhydroxyethylcelluloses, carboxymethylcelluloses, etc.), starches (e.g. starch, hydroxyethylstarch, etc.), polyoxyalkylenes (e.g. PEG, PPG, PEG/PPG copolymers, etc.), carbomers, alginates (e.g. sodium alginate), various gums (e.g. arabic gums, cassia gums, carob gums, scleroglucan gums, xanthan gums, gellan gums, rhamsan gums, karaya gums, carrageenan gums, guar gums, etc.), cocamide derivatives (e.g. cocamidopropyl betaines, etc.), medium to long-chain alkyl and/or fatty alcohols (e.g. cetearyl alcohol, stearyl alcohol, etc.), gelatin, saccharides (e.g. fructose, glucose, PEG-120 methyl glucose diolate, etc.), and the like, as well as derivatives, modifications, and combinations thereof.

In certain embodiments, the composition comprises the pH control agent (F). The pH control agent (F) is not particular limited, and may comprise or be any compound suitable for modifying or adjusting the pH of the composition and/or maintaining (e.g. regulating) the pH of the composition in a particular range. As such, as will be understood by those of skill in the art, the pH control agent (F) comprises, alternatively is a pH modifier (e.g. an acid and/or a base), a pH buffer, or a combination thereof, such as any one or more of those described below.

Examples of acids generally include mineral acids (e.g. hydrochloric acid, phosphoric acid, sulfuric acid, etc.), organic acids (e.g. citric acid, etc.), and the like, as well as derivatives, modifications, and combinations thereof. Examples of bases generally include alkali metal hydroxides (e.g. sodium hydroxide, potassium hydroxide, etc.), carbonates (e.g. alkali metal carbonate salts such as sodium carbonate, etc.), phosphates, and the like, as well as derivatives, modifications, and combinations thereof.

In certain embodiments, the pH control agent (F) comprises, alternatively is, the pH buffer. Suitable pH buffers are not particularly limited, and may comprise, alternatively may be, any buffering compound capable of adjusting the pH of the composition and/or maintaining (e.g. regulating) the pH of the composition in a particular range. As will be understood by those of skill in the art, examples of suitable buffers and buffering compounds may overlap with certain pH modifiers, including those described above, due to the overlap in functions between the additives. As such, when both are utilized in or as the pH control agent (F), the pH buffer and the pH modifier may be independently or collectively selected in view of each other.

In general, suitable pH buffers are selected from buffering compounds that include an acid, a base, or a salt (e.g. comprising the conjugate base/acid of an acid/base). Examples of buffering compounds generally include alkali metal hydroxides (e.g. sodium hydroxide, potassium hydroxide, etc.), carbonates (e.g. sesquicarbonates, alkali metal carbonate salts such as sodium carbonate, etc.), borates, silicates, phosphates, imidazoles, citric acid, sodium citrate, and the like, as well as derivatives, modifications, and combinations thereof. Examples of the some pH buffers include citrate buffers, glycerol buffers, borate buffers, phosphate buffers, and combinations thereof (e.g. citric acid-phosphate buffers, etc.). As such, some examples of particular buffering compounds suitable for use in or as the pH buffer of the pH control agent (F) include ethylenediaminetetraacetic acids (e.g. disodium EDTA, etc.), triethanolamines (e.g. tris(2-hydroxyethyl)amine, etc.), citrates and other polycarboxylic acid-based compounds, and the like, as well as derivatives, modifications, and combinations thereof.

In some embodiments, the composition comprises the foam enhancer (G). Particular compounds/compositions suitable for use in or as the foam enhancer (G) are not limited, and generally include those capable of imparting, enhancing, and or modifying a foaming property (e.g. foamability, foam stability, foam drainage, foam spreadability, foam density, etc.) of the composition, or an end-use composition comprising the same. As such, one of skill in the art will readily appreciate that compounds/compositions suitable for use in or as the foam enhancer (G) may overlap with those described herein with respect to other additives/components of the composition. If utilized, the foam enhancer (G) is different from the anionic polymer (A).

For example, in certain embodiments, the foam enhancer (G) comprises a stabilizing agent selected from electrolytes (e.g. alkali metal and/or alkaline earth salts of various anions, such as chloride, borate, citrate, and/or sulfate salts of sodium, potassium, calcium, and/or magnesium, aluminum chlorohydrates, etc.), polyelectrolytes (e.g. hyaluronic acid salts, such as sodium hyaluronates, etc.), polyols (e.g. glycerine, propylene glycols, butylene glycols, sorbitols), hydrocolloids, and the like, as well as derivatives, modifications, and combinations thereof.

Other examples of foam enhancers suitable for use in or as the foam enhancer (G) are known in the art. For example, the foam enhancer (G) may comprise a polymeric stabilizer, such as those comprising a polyacrylic acid salt, a modified starch, a partially hydrolyzed protein, a polyethyleneimine, a polyvinyl resin, a polyvinyl alcohol, a polyacrylamids, a carboxyvinyl polymer, or combinations thereof. In these or other embodiments, the foam enhancer (G) may comprise a thickener, such as those comprising one or more gums (e.g. xanthan gum), collagen, galactomannans, starches, starch derivatives and/or hydrolysates, cellulose derivatives (e.g. methyl cellulose, hydroxypropylcellulose, hydroxyethyl cellulose, hydroxypropyl methyl cellulose, etc.), colloidal silicic acids, polyvinyl alcohols, vinylpyrrolidone-vinylacetate-copolymers, polyethylene glycols, polypropylene glycols, or the like, or a derivative, modification, or combination thereof.

The composition may comprise one or more additional components/additives, i.e., other than those described above, which are known in the art and will be selected based on the particular components utilized in the composition and a desired end-use thereof. For example, the composition may comprise: a filler; a filler treating agent; a surface modifier; a binder; a compatibilizer; a colorant (e.g. a pigment, dye, etc.); an anti-aging additive; a flame retardant; a corrosion inhibitor; a UV absorber; an anti-oxidant; a light-stabilizer; a heat stabilizer; and the like, as well as derivatives, modifications, and combinations thereof.

The composition may be prepared by combining components (A) and (B), as well as any optional components (e.g. components (C)-(G) described above), in any order of addition, optionally with a master batch, and optionally under mixing.

In certain embodiments, the composition is prepared by pre-mixing component (A) with water to prepare an intermediate composition that is subsequently combined with component (B) to prepare the composition. Likewise, in these or other embodiments, the composition is prepared by pre-mixing component (B) with an optional component to prepare an intermediate composition that is subsequently combined with component (A) to prepare the composition. For example, in certain embodiments, component (B) is combined with the pH control agent (F) to prepare a siloxane cationic surfactant composition, which is subsequently combined with component (B) to prepare the composition. In some such embodiments, the pH control agent (F) is a mineral acid (e.g. HCl) and utilized in an amount sufficient to protonate some, but not all, amine groups of the siloxane cationic surfactant (B), thereby preparing the siloxane cationic surfactant composition as a buffer solution. In view of the embodiments above, one of skill in the art will appreciate that the pH control agent (F) may comprise multiple functions, such as to adjust the pH of one or more individual components of the composition, to buffer one or more intermediate compositions, and/or to modify, control, and/or buffer the pH of the composition by itself or in combination with one or more other components.

The composition may be prepared as a concentrate, e.g. via combining components (A) and (B), optionally together with any of components (C)-(G). Alternatively, when formulated for dilution, the composition may comprise a predominate amount of component (D) (e.g. >50, alternatively >75, alternatively >90 wt. %, based on the total weight of the composition), and still be defined as a concentrate.

The foam stabilizing composition may be formulated as a foam-forming composition (e.g. via diluting a concentrated of the composition, as described above) or utilized as an additive to prepare a foam-forming composition (e.g. via combining the foam stabilizing composition with a base formulation, i.e., a formulation comprising foaming agents, solvents/carriers, additives, etc.). For example, the foaming composition can be prepared by providing water (e.g. as an active flow from a hose, pipe, etc., or in a reaction vessel/reactor), optionally combined with one or more foam additives, and combining the foam stabilizing composition with the water (e.g. as a pre-formed mixture, via addition individual components (A), (B), optionally (C), etc.). In either of such instances, the foam-forming composition comprising the foam stabilizing composition, once prepared, may be aerated or otherwise expanded (e.g. via foaming equipment, application to an aerated water stream/flow, etc.) to form a foam composition (i.e., a “foam”).

The foam prepared with the foam stabilizing composition is suitable for use in various applications. For example, as introduced above, the composition may be utilized in an aqueous foam, or similar such foam, which may be utilized in extinguishing, suppressing, and/or preventing fire. In particular, due to the increased stability provided by the composition, foams prepared therewith may be used for extinguishing fires involving chemicals with low boiling points, high vapor pressures, and/or limited aqueous solubility (e.g. gasoline, organic solvents, etc.), which are typically extremely flammable and/or difficult to maintain/extinguish. For example, such a fire may be extinguished by contacting the fire with foam (e.g. by spraying the foam onto the fire, spraying the foam-forming composition over the fire to prepare the foam thereon, etc.). In similar fashion, the foam may be utilized to secure chemicals (e.g. from a spill or leak thereof) to limit vapor leak and/or ignition, by the applying the foam to the top of the spill/leak, or otherwise forming the foam thereon.

The following examples, illustrating embodiments of this disclosure, are intended to illustrate and not to limit the invention.

Certain components utilized in the Examples are set forth in Table 1 below, which is followed by a brief summary including information regarding certain abbreviations, shorthand notations, structural/chemical descriptions, etc., of particular components utilized in the Examples. With regard to chemical structures, it will be understood that each terminal pendant group not expressly shown is a methyl group (—CH₃) unless otherwise indicated.

TABLE 1
Components Utilized

| Component | Description |
|---|---|
| Anionic Polymer (A1) | Sodium carboxy methyl cellulose |
| Anionic Polymer (A2) | Propylene glycol alginate |
| Anionic Polymer (A3) | Poly-D-galacturonic acid and its methyl ester |
| Anionic Polymer (A4) | Carboxymethyl dextran, sodium salt, DS = 0.294 |
| Anionic Polymer (A5) | Carboxymethyl dextran, sodium salt, DS = 0.409 |
| Anionic Polymer (A6) | Carboxymethyl dextran, sodium salt, DS = 0.619 |
| Comparative Polymer 1 | Methyl cellulose |
| (nonionic) | |
| Comparative Polymer 2 | Cationic hydroxyethyl cellulose |
| (cationic) | |
| Comparative Polymer 3 | Polyvinyl alcohol hydrolyzed (98%) |
| (nonionic) | |
| Zwitterionic Surfactant | Zwitterionic perfluoroalkyl surfactant |
| Siloxane Cationic | , as prepared in Preparation Example 1 |
| Surfactant (B1) | |
| Siloxane Cationic Surfactant (B2) | 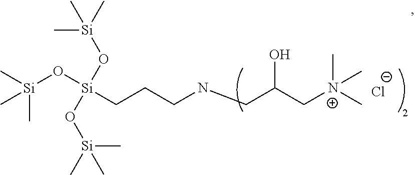 |
| | as prepared in Preparation Example 2 |
| Stability Enhancer (C1) | , as prepared in Preparation Example 3. |
| Stability Enhancer (C2) | A nonionic siloxane surfactant comprising 72 to 92 wt. % of |
| | poly(oxy-1,2-ethanediyl), α-[3-[1,3,3,3-tetramethyl-1- |
| | [(trimethylsilyl)oxy]disiloxanyl]propyl]-ω-hydroxy in polyethylene |
| | oxide monoallyl ether |
| Stability Enhancer (C3) | Alkyl polyglucoside |
| Stability Enhancer (C4) | Cetrimonium chloride |
| Stability Enhancer (C5) | Choline chloride |
| Stability Enhancer (C6) | Ammonium chloride |
| Stability Enhancer (C7) | [2-(methacryloyloxy)ethyl] trimethylammonium chloride |
| Stability Enhancer (C8) | (3-methacrylamidopropyl) trimethylammonium chloride |
| Stability Enhancer (C9) | Benzyltriethylammonium chloride |
| Stability Enhancer (C10) | Tributylmethylammonium chloride |
| Amine 1 | N,N-dimethylhexylamine |
| Amine 2 | N,N-dimethyloctylamine |
| Amine 3 | N,N-dimethyldecylamine |
| Amine 4 | N-octyltrimethylammonium chloride |
| Acid Solution 1 | Hydrochloric acid (0.1N) |
| Acid Solution 2 | Hydrochloric acid (20 wt. %) |
| Base Solution | Sodium hydroxide (0.1N) |
| Buffer Solution | Citric acid buffer |
| Solvent 1 | Glycerol |
| Solvent 2 | Ethanol |
| Solvent 3 | Diethylene glycol butyl ether |
| Diluent | Water |

### Preparation Example 1: Preparation of Siloxane Cationic Surfactant (B1)

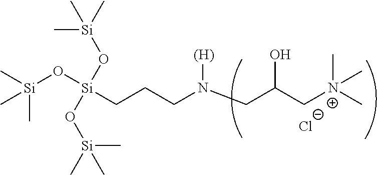

3-aminopropyltris(trimethylsiloxy)silane (601.64 g), Solvent 2 (434.55 g), and Acid Solution 2 (1.25 g) were disposed and mixed in a 2 L glass reactor. The contents of the reactor were stirred and heated to 60° C. Then glycidyltrimethylammonium chloride (381.4 g; 72.7% solution in water) was metered into the reactor over 30 minutes. The contents of the reactor were held at 60° C. for 3-3.5 hours, after which the heat was removed, and Acid Solution 2 (80.50 g) was added once the contents of the reactor were cooled to 30° C. The contents of the reactor were mixed, cooled, and packaged, producing a reaction product in the form of a solution comprising a siloxane cationic surfactant (Siloxane Cationic Surfactant (B1); 58.78 wt % concentration)

### Preparation Example 2: Preparation of Siloxane Cationic Surfactant (B2)

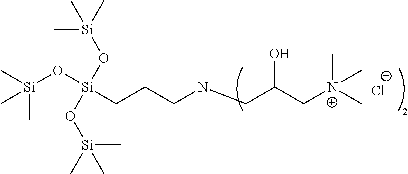

3-aminopropyltris(trimethylsiloxy)silane (3.31 g), glycidyltrimethylammonium chloride (7.42 g; 72.7% solution in water), Solvent 2 (4.32 g), and Acid Solution 2 (0.05 g) were disposed and mixed in a 2 oz vial. The contents of the vial were stirred on a 60° C. heating block to give a mixture, which turned clear within ˜30 minutes. The mixture was stirred for ˜2 hours and then the heat was removed. Then, Acid Solution 2 (0.67 g) was added to the vial, and the contents of the vial were stirred at RT for 1 hour to give a reaction product in the form of a solution comprising a siloxane cationic surfactant (Siloxane Cationic Surfactant (B2); 55.20 wt % concentration).

### Preparation Example 3: Preparation of Stability Enhancer (C1)

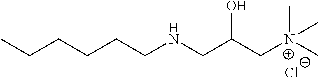

1-hexylamine (391.99 g) and Solvent 2 (227.46 g) were disposed and mixed in a 2 L glass reactor. The contents of the reactor were stirred and heated to 60° C. Then glycidyltrimethylammonium chloride (854.57 g; 72.7% solution in water) was metered into the reactor over 30 minutes. The contents of the reactor were held at 60° C. for 3-3.5 hours, after which the heat was removed, and Acid Solution 2 (225.94 g) was added once the contents of the reactor were cooled to 30° C. The contents of the reactor were mixed, cooled, and packaged, producing a reaction product in the form of a solution comprising a cationic compound (Stability Enhancer (C1); 59.96 wt % concentration).

### Examples 1-29 and Comparative Examples 1-10

Foam stabilizing compositions were prepared for Examples 1-29 and Comparative Examples 1-10. Tables 2-6 below detail the components and amounts utilized in each of the foam stabilizing compositions of Examples 1-29 and Comparative Examples 1-10. The values in Tables 2-6 are in wt. % based on the total weight of each particular foam stabilizing composition. The Wt. Ratio (A)/(B) ratio in each of Tables 2-6 is a weight basis. The Molar Ratio (A)/(B) in Tables 2-4 and 6 is based on the number of moles of ionic groups in component (A) to the number of moles of ionic groups in component (B). C.E. in Table 6 indicates Comparative Example. The foam stabilizing compositions of Examples 1-29 and Comparative Examples 1-10 were prepared by first dispersing the particular Anionic Polymer (A) into Solvent 1, if utilized, to give a slurry. Then, Diluent is combined with the slurry until the Polymer (A) is solubilized in Diluent to give a solution. Then, the Siloxane Cationic Surfactant (B), along with any other surfactants and components utilized, are combined with the solution to give the particular foam stabilizing composition.

TABLE 2
Foam Stabilizing Compositions of Examples 1-7:

| Component: | Ex. 1 | Ex. 2 | Ex. 3 | Ex. 4 | Ex. 5 | Ex. 6 | Ex. 7 |
|---|---|---|---|---|---|---|---|
| (A1) | 0.18 | 0.30 | 0.2 | 0.3 | 0.5 | 0.7 | 1 |
| (B1) | 0.18 | 0.18 | 0.3 | 0.3 | 0.3 | 0.3 | 0.3 |
| (C1) | 0.30 | 0.30 | 0.5 | 0.5 | 0.5 | 0.5 | 0.5 |
| Solvent 1 | 0.90 | 0.90 | — | — | — | — | — |
| Solvent 2 | 0.15 | 0.15 | 0.25 | 0.25 | 0.25 | 0.25 | 0.25 |
| Diluent | 98.29 | 98.17 | 98.75 | 98.65 | 98.45 | 98.25 | 97.95 |
| Wt. Ratio | 1 | 1.67 | 0.67 | 1 | 1.67 | 2.3 | 3.3 |
| (A):(B) | | | | | | | |
| Molar Ratio | 1.70 | 2.84 | 1.14 | 1.70 | 2.84 | 3.91 | 5.61 |
| (A):(B) | | | | | | | |

TABLE 3
Foam Stabilizing Compositions of Examples 8-14:

| | Ex. | Ex. | Ex. | Ex. | Ex. | Ex. | Ex. |
|---|---|---|---|---|---|---|---|
| Component: | 8 | 9 | 10 | 11 | 12 | 13 | 14 |
| (A1) | — | — | — | — | — | — | 0.18 |
| (A2) | 0.5 | — | — | — | — | — | — |
| (A3) | — | 0.5 | 0.18 | — | — | — | — |
| (A4) | — | — | — | 0.5 | — | — | — |
| (A5) | — | — | — | — | 0.5 | — | — |
| (A6) | — | — | — | — | — | 0.5 | — |
| (B1) | 0.3 | 0.3 | 0.18 | 0.3 | 0.3 | 0.3 | 0.18 |
| (C1) | 0.5 | 0.5 | 0.3 | 0.5 | 0.5 | 0.5 | — |
| Amine 1 | — | — | — | — | — | — | 0.30 |
| Acid | — | — | — | — | — | — | 3.15 |
| Solution 1 | | | | | | | |
| Base | — | — | — | — | — | — | 0.74 |
| Solution | | | | | | | |
| Solvent 1 | — | — | 0.45 | — | — | — | 0.45 |
| Solvent 2 | 0.25 | 0.25 | 0.15 | 0.25 | 0.25 | 0.25 | 0.09 |
| Diluent | 98.45 | 98.45 | 98.74 | 98.45 | 98.45 | 98.45 | 94.91 |
| Wt. Ratio | 1.67 | 1.67 | 1 | 1.67 | 1.67 | 1.67 | 1 |
| (A):(B) | | | | | | | |
| Molar Ratio | 5.41 | 4.41 | 2.64 | 1.02 | 1.42 | 2.15 | 1.70 |
| (A):(B) | | | | | | | |

TABLE 4
Foam Stabilizing Compositions of Examples 15-22

| | Ex. | Ex. | Ex. | Ex. | Ex. | Ex. | Ex. | Ex. |
|---|---|---|---|---|---|---|---|---|
| Component: | 15 | 16 | 17 | 18 | 19 | 20 | 21 | 22 |
| (A1) | 0.18 | 0.18 | 0.18 | 0.18 | 0.18 | 0.18 | 0.3 | 0.3 |
| (B1) | 0.18 | 0.18 | — | — | 0.18 | 0.18 | 0.3 | 0.3 |
| (B2) | — | — | 0.09 | 0.09 | — | — | — | — |
| Amine 1 | — | 0.09 | 0.3 | 0.09 | 0.09 | — | — | — |
| Amine 2 | 0.3 | — | — | — | — | — | — | — |
| Amine 4 | — | — | — | — | — | 0.25 | — | — |
| Acid | 1.90 | 1.51 | 2.34 | 1.00 | — | — | — | — |
| Solution 1 | | | | | | | | |
| Buffer | — | — | — | — | 1.97 | — | — | — |
| Solution | | | | | | | | |
| Base | — | — | — | 0.14 | — | — | — | — |
| Solution | | | | | | | | |
| Solvent 1 | 0.45 | 0.45 | 0.45 | 0.45 | 0.45 | 0.45 | — | 0.9 |
| Solvent 2 | 0.09 | 0.09 | 0.04 | 0.04 | 0.09 | 0.15 | 0.25 | 0.25 |
| Diluent | 96.90 | 97.5 | 96.60 | 98.01 | 97.04 | 98.79 | 99.15 | 98.25 |
| Wt. Ratio | 1 | 1 | 2 | 2 | 1 | 1 | 1 | 1 |
| (A):(B) | | | | | | | | |
| Molar Ratio | 1.70 | 1.70 | 1.70 | 1.70 | 1.70 | 1.70 | 1.70 | 1.70 |
| (A):(B) | | | | | | | | |

TABLE 5
Foam Stabilizing Compositions of Examples 23-29

| | Ex. | Ex. | Ex. | Ex. | Ex. | Ex. | Ex. |
|---|---|---|---|---|---|---|---|
| Component: | 23 | 24 | 25 | 26 | 27 | 28 | 29 |
| (A1) | 0.18 | 0.18 | 0.18 | 0.18 | 0.18 | 0.18 | 0.18 |
| (B1) | 0.18 | 0.18 | 0.18 | 0.18 | 0.18 | 0.18 | 0.18 |
| (C5) | — | 0.17 | — | — | — | — | — |
| (C6) | — | — | 0.06 | — | — | — | — |
| (C7) | — | — | — | 0.25 | — | — | — |
| (C8) | — | — | — | — | 0.26 | — | — |
| (C9) | — | — | — | — | — | 0.27 | — |
| (C10) | — | — | — | — | — | — | 0.28 |
| Solvent 1 | 0.45 | 0.45 | 0.45 | 0.45 | 0.45 | 0.45 | 0.45 |
| Solvent 2 | 0.15 | 0.25 | 0.25 | 0.25 | 0.25 | 0.25 | 0.25 |
| Diluent | 99.04 | 98.77 | 98.88 | 98.69 | 98.68 | 98.67 | 97.66 |

TABLE 6
Foam Stabilizing Compositions of Comparative Examples 1-10:

| Component: | C.E. 1 | C.E. 2 | C.E. 3 | C.E. 4 | C.E. 5 | C.E. 6 | C.E. 7 | C.E. 8 | C.E. 9 | C.E. 10 |
|---|---|---|---|---|---|---|---|---|---|---|
| (A1) | — | — | 0.05 | 0.10 | — | — | — | 0.5 | 0.22 | 1.2 |
| Comparative | — | — | — | — | 0.5 | — | — | — | — | — |
| Polymer 1 | | | | | | | | | | |
| Comparative | — | — | — | — | — | 0.5 | — | — | — | — |
| Polymer 2 | | | | | | | | | | |
| Comparative | — | — | — | — | — | — | 0.5 | — | — | — |
| Polymer 3 | | | | | | | | | | |
| Zwitterionic | 0.08 | — | — | — | — | — | — | — | — | — |
| Surfactant | | | | | | | | | | |
| (B1) | — | 0.30 | 0.30 | 0.30 | 0.30 | 0.30 | 0.30 | — | — | 0.30 |
| (C1) | — | 0.50 | 0.50 | 0.50 | 0.50 | .50 | 0.50 | — | — | 0.50 |
| (C2) | — | — | — | — | — | — | — | 0.30 | — | — |
| (C3) | 0.14 | — | — | — | — | — | — | — | — | — |
| (C4) | — | — | — | — | — | — | — | — | 0.22 | — |
| Solvent 2 | 0.22 | 0.25 | 0.25 | 0.25 | 0.25 | 0.25 | 0.25 | — | — | 0.25 |
| Solvent 3 | 0.50 | — | — | — | — | — | — | — | — | — |
| Diluent | 99.17 | 98.95 | 98.9 | 98.85 | 98.45 | 98.45 | 99.45 | 99.20 | 99.56 | 97.75 |
| Wt. Ratio | n/a | n/a | 0.17 | 0.33 | n/a | n/a | n/a | n/a | n/a | 4 |
| (A):(B) | | | | | | | | | | |
| Molar Ratio | n/a | n/a | 0.29 | 0.56 | n/a | n/a | n/a | n/a | n/a | 6.80 |
| (A):(B) | | | | | | | | | | |

### Foam Stability Test Procedure:

Parker Eight 10 oz handhold foaming soap dispenses were used to generate foams with the foam stabilizing compositions of Examples 1-29 and Comparative Examples 1-10. A flat-bottom crystallizing dish with a diameter of 100 mm and height of 50 mm was used to contain heptane. A digital camera (Canon Rebel T3i) with an 18-55 mm lens was used to capture images of the foams from the side of the dish at fixed time intervals to visualize the dynamics of foam collapse. The light source, focus, aperture, and shutter speed were adjusted manually according to needs. 40 mL of heptane was first poured into the dish. The dish was heated on a hot plate to allow heptane to reach 60° C. and maintained at that temperature. Then, 100 mL of foam formed with each of the foam stabilizing compositions of Examples 1-29 and Comparative Examples 1-10 was dispensed on top of the hot heptane. The hot plate was subsequently switched off and a timer was started. The timer was stopped when a hole formed in the foam blanket which exposed the heptane underneath. The foam stability time was recorded.

Table 7-9 below detail the foam stability time associated with the foams formed with the foam stabilizing compositions of Examples 1-29 and Comparative Examples 1-10 in accordance with the foam stability test procedure described above.

TABLE 7
Foam Stability Time of Examples 1-11

| Example: | 1 | 2 | 3 | 4 | 5 | 6 | 7 | 8 | 9 | 10 | 11 |
|---|---|---|---|---|---|---|---|---|---|---|---|
| Foam stability | 17.8 | 12.5 | 4 | 7.5 | 7 | 6 | 4 | 12 | 12 | 5 | 6.5 |
| time (Min) | | | | | | | | | | | |

TABLE 8
Foam Stability Time of Examples 12-22

| Example: | 12 | 13 | 14 | 15 | 16 | 17 | 18 | 19 | 20 | 21 | 22 |
|---|---|---|---|---|---|---|---|---|---|---|---|
| Foam stability | 6.5 | 6.5 | 6.5 | 4 | 4.5 | 7.5 | 7 | 9 | 14 | 5 | 19 |
| time (Min) | | | | | | | | | | | |

TABLE 9
Foam Stability Time of Examples 23-29

| Example: | 23 | 24 | 25 | 26 | 27 | 28 | 29 |
|---|---|---|---|---|---|---|---|
| Foam stability | 5.17 | 8.13 | 6.67 | 8.17 | 11.75 | 15.25 | 14.16 |
| time (Min) | | | | | | | |

TABLE 10
Foam Stability Time of Comparative Examples 1-10

| Example: | C.E. 1 | C.E. 2 | C.E. 3 | C.E. 4 | C.E. 5 | C.E. 6 | C.E. 7 | C.E. 8 | C.E. 9 | C.E. 10 |
|---|---|---|---|---|---|---|---|---|---|---|
| Foam stability | >20 | 2.5 | 0.1 | 0.1 | 0.42 | 1 | 1.5 | 0.5 | 3.5 | n.d.* |
| time (Min) | | | | | | | | | | |

n.d.* means not detected due to the high viscosity of the particular composition of Comparative Example 10.

### Pool Test General Procedure:

A 19 cm diameter, 11 cm deep borosilicate glass container with an outlet at the bottom was used to contain a fuel pool. A heptane fuel layer (1 cm thick) was formed on top of a water layer (9 cm deep) with a 1 cm lip above the fuel layer to accommodate the foam. Foam was generated and applied onto the center of the pool at a constant foam flow rate. The constant foam flow rate was achieved by maintaining constant air flow and by a liquid leveling system that continuously transferred additional foam stabilizing composition from a leveling vessel to a foam generation vessel. This liquid level was maintained at 3 cm above a sparger disc. Extinction experiments consisted of a pre-burn of the heptane pool for 60 s followed by the foam application at a constant flow rate until fire extinguishment, which is measured as extinction time as a function of flow rate. If when no extinction event was observed at low foam flow rates, foam flow was turned off after 180 s to prevent overflow of the foam. As the foam drained liquid into the fuel, fuel overflow from an extinction vessel was prevented by lowering a tygon tube connected to the bottom of the extinction vessel to a specified height. The same general procedure was repeated with gasoline instead of heptane.

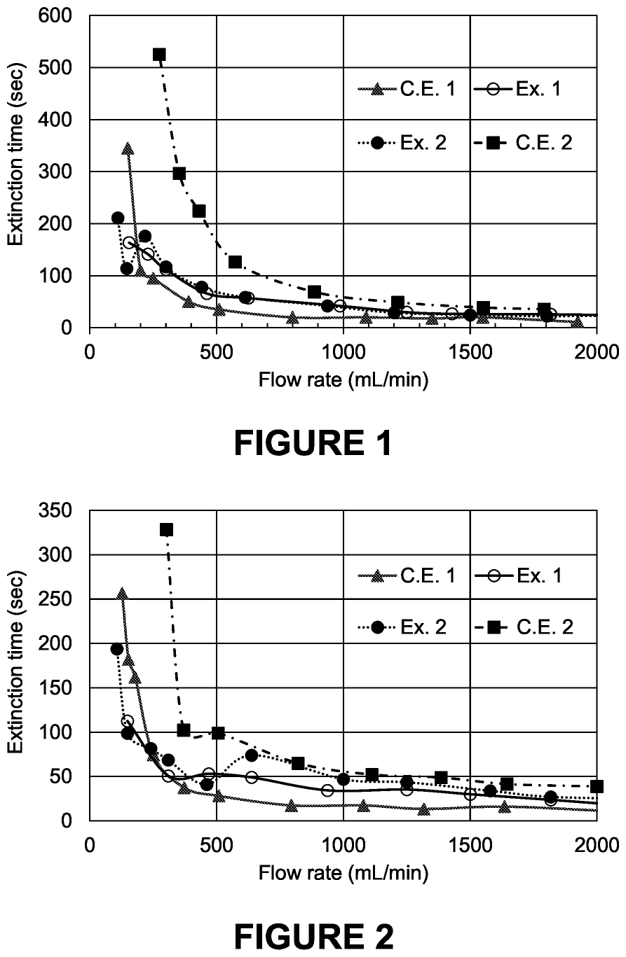

Tables 11 and 13 show the extinction times for foams formed with Examples 1 and 2 and Comparative Examples 2 and 3 for gasoline and heptane, respectively, as measured in accordance with the Pool Test General Procedure. The data from Table 11 is included herewith as FIG. 1, and the data from Table 13 is included herewith as FIG. 2.

TABLE 11
Extinction Times for Gasoline

| C.E. 1 | | C.E. 2 | | Ex. 1 | | Ex. 2 | |
|---|---|---|---|---|---|---|---|
| Flow rate | Extinction | Flow rate | Extinction | Flow rate | Extinction | Flow rate | Extinction |
| (ml/min) | time (s) | (mL/min) | time (s) | (mL/min) | time (s) | (mL/min) | time (s) |
| 150 | 345 | 274 | 525 | 155 | 164 | 110 | 211 |
| 200 | 110 | 353 | 297 | 229 | 141 | 145 | 114 |
| 250 | 95 | 431 | 225 | 300 | 112 | 217 | 176 |
| 390 | 50 | 573 | 126 | 462 | 66 | 300 | 117 |
| 510 | 35 | 885 | 69 | 625 | 57 | 441 | 78 |
| 800 | 20 | 1214 | 49 | 987 | 42 | 612 | 59 |
| 1090 | 20 | 1552 | 39 | 1250 | 30 | 938 | 42 |
| 1350 | 18 | 1792 | 36 | 1429 | 27 | 1200 | 29 |
| 1550 | 20 | 2117 | 27 | 1818 | 26 | 1500 | 25 |
| 1925 | 11 | | | 2308 | 22 | 1802 | 22 |
| | | | | | | 2166 | 24 |

TABLE 12
Extinction and Burnback Time for Gasoline
for Examples 23, 24, 27, and 28

| Example | Extinction time (sec) | Burnback time (min) |
|---|---|---|
| Ex. 23 | Did not extinguish | Not tested |
| Ex. 24 | 80 | 3.08 |
| Ex. 27 | 112 | 2.25 |
| Ex. 28 | 103 | 2.83 |

TABLE 13
Extinction Times for Heptane

| C.E. 1 | | C.E. 2 | | Ex. 1 | | Ex. 2 | |
|---|---|---|---|---|---|---|---|
| Flow rate | Extinction | Flow rate | Extinction | Flow rate | Extinction | Flow rate | Extinction |
| (ml/min) | time (s) | (ml/min) | time (s) | (mL/min) | time (s) | (mL/min) | time (s) |
| 128 | 256 | 302 | 329 | 149 | 113 | 107 | 194 |
| 153 | 182 | 370 | 102 | 309 | 51 | 149 | 99 |
| 179 | 162 | 506 | 99 | 469 | 53 | 240 | 82 |
| 251 | 74 | 821 | 65 | 638 | 49 | 309 | 69 |
| 372 | 37 | 1113 | 52 | 938 | 34 | 462 | 41 |
| 509 | 28 | 1385 | 49 | 1250 | 35 | 638 | 74 |
| 795 | 17 | 1645 | 41 | 1500 | 30 | 1000 | 47 |
| 1079 | 17 | 2000 | 39 | 1818 | 24 | 1250 | 43 |
| 1318 | 13 | | | 2143 | 17 | 1579 | 34 |
| 1636 | 16 | | | | | 1818 | 27 |
| 2067 | 11 | | | | | 2222 | 25 |

### Foam Collection:

Foam was collected using a stainless steel foam slider with dimensions specified by the UL-162 and EN 1568 standards. A stainless steel collection vessel (100 mm diameter, 200 mm in height) was positioned at the base of the slider to collect the foam. The collection vessel has a 0.25 inch orifice at its base that was fit with a brass barbed hose fitting for 0.25 inch ID hose (McMaster-Carr, Catalog number 5346K42). Tygon tubing (ID=0.25 inch, wall thickness= 1/16 inch) was attached to the barbed hose fitting. A needle valve was attached to the opposite end of the Tygon tubing with ˜40 mm of tubing in between the hose fitting and the needle valve. After priming the nozzle, foam was sprayed onto the foam slider so that it would flow into the collection vessel (the needle valve was closed during foam collection). When the foam reached the top of the collection vessel, a stopwatch was started to track the age of the foam for subsequent drainage time evaluation.

### Expansion Ratio:

The expansion ratio of a foam is the ratio of foam volume to the volume of liquid foam solution. Assuming the liquid foam solution has a density similar to water and approximating it as 1 g/mL, the volume of the liquid foam solution can be approximated by the mass of the foam. The expression for the expansion ratio is

$$Expansion Ratio = \frac{{V}_{f}}{{V}_{l i q}} = \frac{{V}_{f}}{{m}_{f}} , \qquad ( 1 )$$

Where V_{f} is the foam volume, V_{liq} is the volume of the liquid solution in the foam, and m_{f} is the mass of the foam. After filling the collection vessel with foam using the foam slider, the outside of the container was wiped clean with paper towels. The mass of foam was recorded to the nearest gram by weighing the tared collection vessel containing foam. The expansion ratio was calculated by dividing the volume of foam (1600 mL) by the mass of foam according to Equation above using three different methods: (1) graduated cylinder method, (2) nozzle to jar collection method, and (3) ratio of drainage rates.

### Drainage Time:

Drainage time measurements were based on UL 162 and EN 1568 standards. In particular, with the needle valve closed, the collection vessel was filled with foam using the foam slider as described above (see Foam Collection). When the foam reached the top of the vessel, a stopwatch was started and the outside of the vessel was wiped clean using paper towels. After weighing the vessel for the expansion ratio calculation, the vessel was clamped to a ring stand and positioned over a 500 mL glass graduated cylinder. The graduated cylinder was on a balance connected to a computer to automatically record mass as a function of time. Before starting the drainage experiment, the graduated cylinder was tared on the balance.

To measure the drainage time of the foam, the needle valve was slowly opened at the same time that the balance began recording mass (1 measurement every 2 seconds). The time of the stopwatch was also recorded to later correct the times recorded by the computer to reflect the age of the foam. The needle valve was only opened enough so that liquid (not foam) was able to drain into the graduated cylinder as it drained from the foam.

A camera (Canon EOS Rebel T3i) was set up on a tripod to image the graduated cylinder. A piece of black poster board was positioned behind the graduated cylinder. The camera was connected to a computer and controlled remotely using the Canon EOS Utility software.

The mass drained was plotted as a function of foam age. A short script was written in MATLAB to identify the time at which the mass collected first exceeded 25% of the mass of the foam in the collection vessel at the start of the experiment; it was recorded as the 25% drain time. Because the 25% drain time is reported to the nearest minute, small errors associated with starting the stopwatch and syncing the stopwatch to the computer recording start time are insignificant.

### MILSPEC MIL-F-24385 Test:

Six foot diameter pool fire tests outlined in MIL-F-24385 were performed. However, the same test was carried out with gasoline, heptane, and Jet A fuel as the fuel. An active firefighter was involved in spraying foam on to the pool surface unlike in the Pool Test General Procedure. Extinction time was measured from the time of initiating deposition of the foam onto the 2.6 m² fuel pool fire, which had been burning 10 s (pre-burn) before starting the foam application, until the time of extinguishment. The burnback test involved a reignition of the extinguished pool fire after 90 s of total foam application (includes time to extinguish fire). The foam covered pool was reignited by lowering a 30.5 cm diameter pan of burning fuel into the center of the pool and recording the time for fire reinvolving 25% of the pool surface. The film and seal test was con-ducted by covering the fuel surface in a small container with foam, then inserting a wire screen to scoop out the residual foam, waiting 60 s then placing a small butane lighter flame approximately 1.27 cm above the surface to ignite the fuel vapors permeating through the water-surfactant film on the fuel surface. If the fuel did not ignite, it received a pass. Table 14 below shows the results of the MILSPEC MIL-F-24385 Test for Example 1 and Comparative Examples 1-2.

TABLE 14
MILSPEC MIL-F-24385 Test Results for Example 1 and Comparative
Examples 1-2:

| | | | | Example | | | | | |
|---|---|---|---|---|---|---|---|---|---|
| Parameter | Criteria | | Fuel | C.E. 1 | | Ex. 1 | | C.E. 2 | |
| Flow rate | 2 | gpm | — | 2 | gpm | 2 | gpm | 2 | gpm |
| Extinction | <30 | sec | Gasoline | 24 | sec | 31.9 | sec | 42 | sec |
| | | | Heptane | 30 | sec | 66 | sec | 51 | sec |

| | | | | | |
|---|---|---|---|---|---|
| Jet A | Did not test | 21.5 | sec | 19 | sec |

| | | | | | | |
|---|---|---|---|---|---|---|
| 25% Burnback | >6 | min | Gasoline | 12 min 39 sec | 9 min 51 | 4 min 53 |
| | | | | | sec | sec |
| | | | Heptane | 16 min 21 sec | 11 min 12 | 4 min 18 |
| | | | | | sec | sec |
| | | | Jet A | Did not test | 14 min 31 | 9 min 23 |
| | | | | | sec | sec |

| | | | | | |
|---|---|---|---|---|---|
| PKP | Pass/Fail | Jet A | Pass | Pass | Did not |
| Compatibility | | | | | test |
| Expansion Ratio | 5-10 | — | 7.5 | 5.3 | 5.1 |
| 25% Drainage | 2 min 30 sec | — | 4 min 11 | 6 min 6 sec | 2 min 54 |
| Time | | | sec | | sec |

### UL 162 Type II Test:

55 gallons of fuel was first dispensed in a 50 sq. ft. square metal pan. A torch was used to ignite the fuel which was allowed to burn for 1 minute. After a minute, the valve on the foam premix tank was opened and foam was dispensed by shooting it directly at a backboard fixed to the back of the metal pan. The target on the back wall of the pan was 12-18 inches above the fuel along the centerline of the pan. The extinction time was directly recorded by firefighters observing the pool fire. Foam was dispensed for a full 5 minutes, even if the fire was extinguished before that. However, if the fire persisted beyond 5 minutes, additional foam was dispensed until complete extinction was achieved. 1 minute after foam dispensing was stopped, a lit propane torch with an extended wand was waved slowly over the top of the foam, close to the surface. Passing or failure of the torch test was defined by the presence of sustained flames 30 seconds after waving the torch over the surface of the foam blanket. The burnback test occurred 10 minutes after stopping foam application in the pan. This test involved inserting a 12-inch diameter steel cylinder (approximately 18 inches long) into the pan and manually removing the foam within the pipe using a ladle. At the designated time, the torch was used to reignite the fuel within the cylinder. The fire was allowed to burn for 1 minute before the pipe was lifted straight up and out of the pan and set aside. The fire was observed for 5 minutes or until extinguishment. A pass as defined by the UL 162 standard is <20% area of the pan reignited after 5 minutes. Table 15 below shows the results of the UL 162 Type II Test for Example 1 and Comparative Example 2.

TABLE 15
UL 162 Type II Test Results for Example 1 and Comparative Example 2:

| | | | Performance | |
|---|---|---|---|---|
| Parameter | Criteria | Fuel | Ex. 1 | C.E. 2 |
| Flow rate | 3 gpm | — | 3 gpm | 3 gpm |
| Extinction | <5 min | Heptane | 3 min 45 | 8 min 31 |
| | | | sec | sec |
| Torch | Pass/Fail | Heptane | Pass | Fail |
| 20% Burnback | >5 min | Heptane | 4 min 42 | Did not |
| | | | sec | test |
| Expansion Ratio | — | — | 5.9 | 4.9 |
| 25% Drainage | — | — | 4 min 6 sec | 2 min 30 |
| Time | | | | sec |

FIGS. 1 and 2 show that Examples 1 and 2 extinguish gasoline and heptane fires much faster than Comparative Example 2 (which does not include component (A)) at all the foam flow rates tested. Moreover, the extinction time of Examples 1 and 2 is even shorter than the extinction time of fluorine containing Comparative Example 1 at foam flow rates less than 200 mL/min for both gasoline and heptane. Comparative examples 2, 5, 6, 7, 8, and 9 in Table 10 show that in the absence of any one or more of components (A) and (B), foam stability is much lower as compared to that of the Examples.

1. A foam stabilizing composition, comprising:
(A) an anionic polymer; and
(B) a siloxane cationic surfactant having general formula (I):
[Z¹-D¹-N(Y)ₐ(R)₂₋ₐ]^{+y}[X^{-x}]ₙ (I),
wherein Z¹ is a siloxane moiety; D¹ is a divalent linking group; R is H or an unsubstituted hydrocarbyl group having from 1 to 4 carbon atoms; each Y has formula -D-NR¹₃_{⁺}, where D is a divalent linking group and each R¹ is independently an unsubstituted hydrocarbyl group having from 1 to 4 carbon atoms; subscript a is 1 or 2; 1≤y≤3; X is an anion; subscript n is 1, 2, or 3; and 1≤x≤3, with the proviso that (x*n)=y;
wherein at least one of the following provisos is true:
(i) components (A) and (B) are present in the foam stabilizing composition in a weight ratio of from 0.5:1 to 3.5:1 (A)/(B); and/or
(ii) components (A) and (B) are present in the foam stabilizing composition to provide a molar ratio of anionic groups in component (A) to cationic groups in component (B) of from 1:1 to 6.5:1;
wherein component (A) is selected from sodium carboxy methyl cellulose, propylene glycol alginate, poly-D-galacturonic acid and its methyl ester, carboxymethyl dextran (sodium salt), and combinations thereof.

2. The foam stabilizing composition of claim 1, wherein proviso (i) is true.

3. The foam stabilizing composition of claim 1, wherein proviso (ii) is true, wherein the foam stabilizing composition further comprises water, and wherein a weight ratio of water to component (A) is from 90:1 to 600:1.

4. The foam stabilizing composition of claim 1, wherein: (i) the anionic polymer (A) comprises a polyelectrolyte polymer; (ii) the anionic polymer is soluble in water; or (iii) both (i) and (ii).

5. The foam stabilizing composition of claim 1, wherein the siloxane moiety Z¹ has the formula: 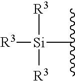
where each R³ is independently selected from R² and —OSi(R⁴)₃, with the proviso that at least one R³ is —OSi(R⁴)₃; where each R⁴ is independently selected from R², —OSi(R⁵)₃, and —[OSiR²₂]ₘOSiR²₃; where each R⁵ is independently selected from R², —OSi(R⁶)₃, and —[OSiR²₂]ₘOSiR²₃; where each R⁶ is independently selected from R² and —[OSiR²₂]ₘOSiR²₃; where 0≤m≤100; and where each R² is independently a substituted or unsubstituted hydrocarbyl group.

6. The foam stabilizing composition of claim 1, wherein the siloxane moiety Z¹ has one of the following structures (i)-(iv):

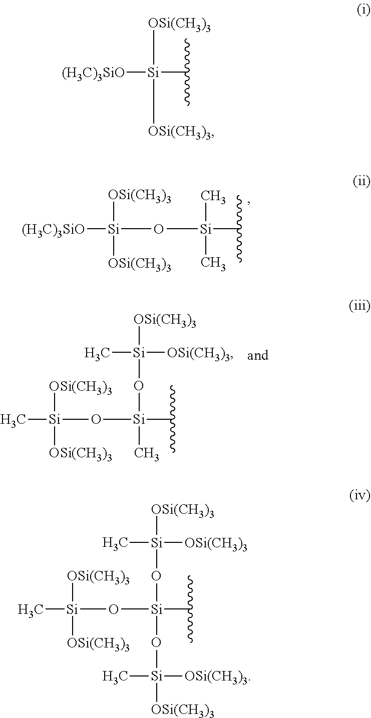

7. The foam stabilizing composition of claim 1, wherein: (i) D¹ is a branched or linear alkylene group; or (ii) D¹ has formula -D³-N(R⁷)-D³-, where each D³ is an independently selected divalent linking group and R⁷ is H or Y, where Y is independently selected and as defined above.

8. The foam stabilizing composition of claim 1, wherein component (B) has at least one of the following formulas:

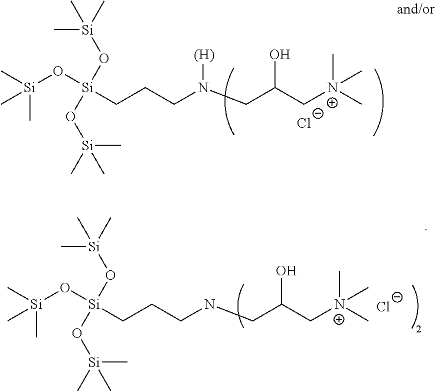

9. The foam stabilizing composition of claim 1, further comprising (C) a stability enhancer other than component (B).

10. The foam stabilizing composition of claim 9, wherein a weight ratio of component (C) to component (B) is from greater than 0:1 to 10:1.

11. The foam stabilizing composition of claim 9, wherein the stability enhancer (C) has one of the general formulas (II) or (III):
[Z²-D²-N(Y)_{b}(R)_{2-b}]^{+y}[X^{-x}]ₙ (II),
[(Z²-D²)_{c}-N⁺(R)_{4-c}]^{+y}[X^{-x}]ₙ (III),
wherein Z² is a substituted or unsubstituted hydrocarbyl group or a functional group; D² is a covalent bond or a divalent linking group; subscript b is 1 or 2; subscript c is 0, 1, 2, 3, or 4; and each R, Y, superscript y, X, subscript n, and superscript x is independently selected and as defined above.

12. The foam stabilizing composition of claim 11, wherein component (C) has formula (II) and wherein Z² is an alkyl group having from 6 to 18 carbon atoms.

13. The foam stabilizing composition of claim 1, wherein: (i) each D¹ is selected from —CH₂CH(OH)CH₂— and —HC(CH₂OH)CH₂—; (ii) each R1 is methyl; (iii) each X is Cl and superscript x is 1; or (iv) any combination of (i)-(iii).

14. An aqueous foam comprising water and the foam stabilizing composition of claim 1.

15. A method of extinguishing a fire comprising contacting the fire with the aqueous foam of claim 14.
